(19) United States
(12) Patent Application Publication
(10) Pub. No.: US 2026/0322429 A1
(43) Pub. Date: Oct. 15, 2026

(54) MULTI-ACCESS POINT COORDINATION

(71) Applicant: Comcast Cable Communications, LLC, Philadelphia, PA (US)

(72) Inventors: Leonardo Alisasis Lanante, Reston, VA (US); Jeongki Kim, Fairfax, VA (US); Esmael Hejazi Dinan, McLean, VA (US); Jiayi Zhang, Rockville, MD (US); Serhat Erkucuk, Reston, VA (US)

(21) Appl. No.: 19/643,723

(22) Filed: Apr. 9, 2026

Related U.S. Application Data
(60) Provisional application No. 63/785,817, filed on Apr. 9, 2025.
(60) Provisional application No. 63/797,175, filed on Apr. 30, 2025.

(51) Int. Cl. H04B 7/0408; H04W 84/12

(52) U.S. Cl. CPC H04B 7/0408; H04W 84/12

(57) ABSTRACT

Multiple access points may communicate with multiple wireless devices, such as stations. An invitation transmitted between access points may indicate participation in a coordinated transmission. A response associated with the invitation may indicate whether the participation is accepted or rejected. Information included in the response, such as timing information and/or a reason associated with a rejection, may be used for subsequent transmissions.

### CROSS REFERENCE RELATED TO OTHER APPLICATIONS

This application claims the benefit of U.S. Provisional Application No. 63/785,817 filed on Apr. 9, 2025, and U.S. Provisional Application No. 63/797,175 filed on Apr. 30, 2025. Each of the above referenced applications is hereby incorporated by reference in its entirety.

### BACKGROUND

Multiple access points communicate with multiple wireless devices, such as stations. Coordinated beamforming is used to estimate channel conditions for such communications.

### SUMMARY

The following summary presents a simplified summary of certain features. The summary is not an extensive overview and is not intended to identify key or critical elements.

Multiple access points may communicate with multiple wireless devices, such as stations. An invitation may be transmitted by an access point to another access point to request participation in a coordinated transmission, such as in a coordinated beamforming. A response may be transmitted to indicate whether the invitation is accepted or rejected. Additional information, such as timing information and/or one or more reasons associated with a rejection to an invitation may be included in the response. The response may be used to determine whether and/or when one or more subsequent invitations are to be transmitted. By using information in the response, access points may reduce unnecessary transmissions of invitations and/or rejections. These and other features and advantages are described in greater detail below.

### BRIEF DESCRIPTION OF THE DRAWINGS

Examples of several of the various embodiments of the present disclosure are described herein with reference to the drawings.

FIG. 1 shows example wireless communication networks.

FIG. 2 shows a block diagram showing example implementations of a station (STA) and an access point (AP).

FIG. 3 shows an example of a Medium Access Control (MAC) frame format.

FIG. 4 shows an example network that comprises a coordinated AP set.

FIG. 5 shows an example multi-AP operation procedure.

FIG. 6 shows an example control frame which may be used as a trigger frame.

FIG. 7 shows an example block acknowledgment frame

FIG. 8 shows an example of a trigger based (TB) sounding sequence.

FIG. 9 shows an example of sequential NDP sounding.

FIG. 10 shows an example of joint NDP sounding.

FIG. 11 shows an example multi-AP downlink data transmission phase.

FIG. 12 shows an example NDP sounding procedures.

FIG. 13 shows an example problem in multi-AP coordinated transmission.

FIG. 14 shows an example method for a multi-AP coordinated transmission.

FIG. 15 shows an example method for a multi-AP coordinated transmission.

FIG. 16 shows an example method for a multi-AP coordinated transmission.

FIG. 17 shows an example method for a multi-AP coordinated transmission.

FIG. 18 shows an example method for a multi-AP coordinated transmission.

FIG. 19 shows an example method for a multi-AP coordinated transmission.

FIG. 20 shows an example method for a multi-AP coordinated transmission.

FIG. 21 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems.

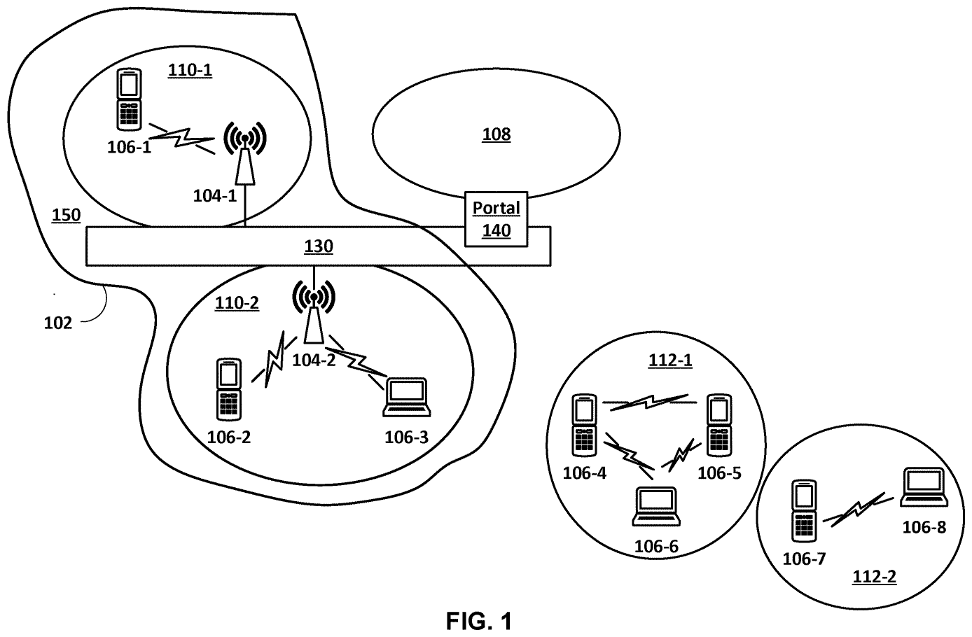

FIG. 1 shows example wireless communication network 100. The example wireless communication networks may be a wireless local area network (WLAN) 102. The WLAN 102 may comprise an Institute of Electrical and Electronic Engineers (IEEE) 802.11 infra-structure network, or any other type of communication network. The WLAN 102 may comprise one or more basic service sets (BSSs) 110-1 and 110-2. BSSs 110-1 and 110-2 may each include a set of an access point (AP or AP station (STA)) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS may be configured to perform an association procedure to communicate with each other.

The WLAN 102 may comprise a distribution system (DS) 130. DS 130 may be configured to connect BSS 110-1 and BSS 110-2. DS 130 may enable an extended service set (ESS) 150 by being configured to connect BSS 110-1 and BSS 110-2. The ESS 150 may be a network comprising one or more Aps (e.g., Aps 104-1 and AP 104-2) that may be connected via the DS 130. The APs included in ESS 150 may have the same service set identification (SSID). WLAN 102 may be coupled to one or more external networks. For example, WLAN 102 may be connected to another network 108 (e.g., 802.X) via a portal 140. Portal 140 may function as a bridge connecting DS 130 of WLAN 102 with the other network 108.

The example wireless communication networks shown in FIG. 1 may further include one or more ad-hoc networks or independent BSSs (IBSSs). An ad-hoc network or IBSS may be a network that includes a plurality of STAs that are within communication range of each other. The plurality of STAs may be configured so that the plurality of STAs may communicate with each other using direct peer-to-peer communication (e.g., not via an AP).

For example, STAs 106-4, 106-5, and 106-6, in FIG. 1, may be configured to form a first IBSS 112-1. STAs 106-7 and 106-8 may be configured to form a second IBSS 112-2. An IBSS may not include a centralized management entity. The IBSS may not include a centralized management entity, for example, if an IBSS does not include an AP. STAs within an IBSS may be managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. The preamble fields may be duplicated and sent (e.g., transmitted) in each of the multiple component channels, in instances in which PPDUs are sent (e.g., transmitted) over a bonded channel (channel formed through channel bonding). The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The information provided in, and the format and coding of the non-legacy portion of the preamble may be based on the particular IEEE 802.11 protocol to be used to send (e.g., transmit) the payload.

A frequency band may include one or more sub-bands or frequency channels. For example, PPDUs conforming to the IEEE 802.11n, 802.11ac, 802.11ax and/or 802.11be standard amendments may be sent (e.g., transmitted) over the 2.4 GHz, 5 GHz, and/or 6 GHz bands, each of which may be divided into multiple 20 MHz channels. The PPDUs may be sent (e.g., transmitted) over a physical channel having a minimum bandwidth of 20 MHz. Larger channels may be formed through channel bonding. PPDUs may be sent (e.g., transmitted) over physical channels having bandwidths of 40 MHz, 80 MHz, 160 MHz, or 520 MHz by bonding together multiple 20 MHz channels.

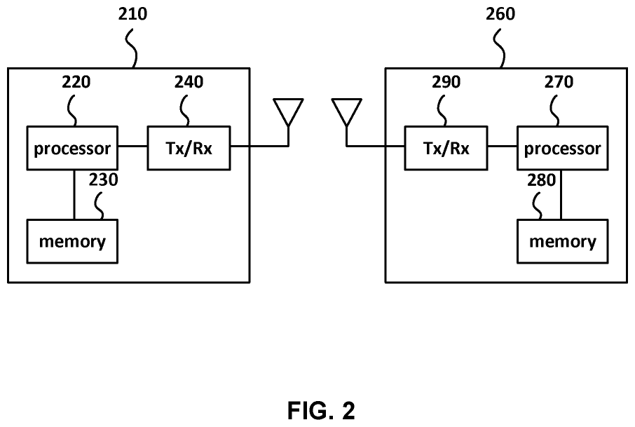

FIG. 2 is a block diagram 200 showing example implementations of a STA 210 and an AP 260. STA 210, as shown in FIG. 2, may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to send/transmit/receive radio signals. The transceiver 240/290 may implement a PHY layer of the corresponding device (STA 210 or AP 260). STA 210 and/or AP 260 may be a multi-link device (MLD), that is a device capable of operating over multiple links as defined by the IEEE 802.11 standard. STA 210 and/or AP 260 may each implement multiple PHY layers. The multiple PHY layers may be implemented using one or more of transceivers 240/290.

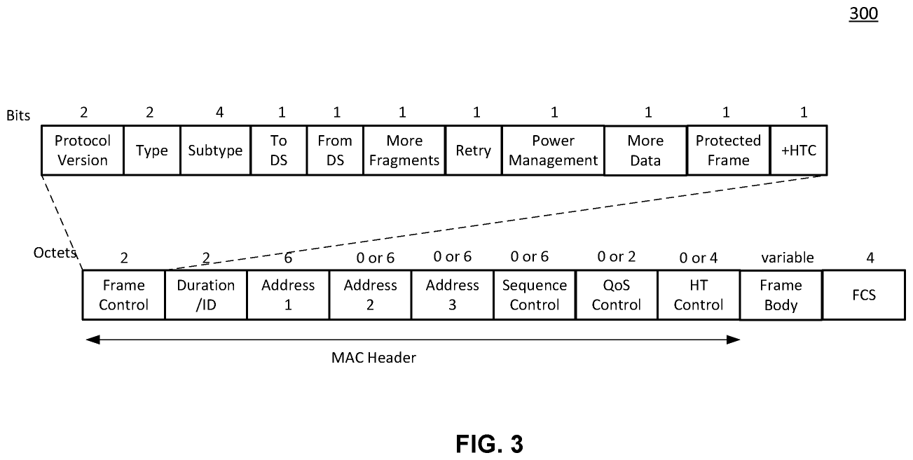

FIG. 3 shows an example format of a MAC frame. A STA in operation may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame may include a MAC header, a variable length frame body, and a frame check sequence (FCS). The MAC header may include a frame control field, an optional duration/ID field, address fields, an optional sequence control field, an optional QoS control field, and an optional HT control field. The frame control field may include the following subfields: protocol version, type, subtype, “To DS”, “From DS”, “More Fragments”, retry, power management, “More Data”, protected frame, and +HTC (high throughput control). The protocol version subfield may be invariant in size and placement across all revisions of the IEEE 802.11 standard. The value of the protocol version subfield may be 0 for MAC frames.

The type and subtype subfields together may identify the function of the MAC frame. There may be three frame types: control, data, and management. Each of the frame types may have several defined subtypes. Bits within the subtype subfield may be used to indicate a specific modification of the basic data frame (subtype 0). For example, in data frames, the most significant bit (MSB) of the subtype subfield, bit 7 (B7) of the frame control field, may be defined as the QoS subfield. A QoS data frame may be indicated, which is a data frame that contains a QoS control field in its MAC header, if the QoS subfield is set to 1. The second MSB of the subtype field, bit 6 (B6) of the frame control field, if set to 1 in data subtypes, indicates a data frame that contain no frame body field.

The “To DS” subfield may indicate whether a data frame is destined to the distribution system (DS). The “From DS” subfield may indicate whether a data frame originates from the DS.

The “More Fragments” subfield may be set to 1 in all data or management frames that have another fragment to follow the MAC service data unit (MSDU) or MAC management protocol data unit (MMPDU) carried by the MAC frame. The “More Fragments” subfield may be set to 0 in all other frames in which the “More Fragments” subfield is present.

The retry subfield may be set to 1 in any data or management frame that is a retransmission of an earlier frame. It may be set to 0 in all other frames in which the retry subfield is present. A receiving STA may use this indication to aid it in the process of eliminating duplicate frames. These rules may not apply for frames sent by a STA under a block agreement. The power management subfield may be used to indicate the power management mode of a STA.

The “More Data” subfield may indicate to a STA in power save (PS) mode that bufferable units (BUs) are buffered for that STA at the AP. The “More Data” subfield may be valid in individually addressed data or management frames sent (e.g., transmitted) by an AP to a STA in PS mode. The “More Data” subfield may be set to 1 to indicate that at least one additional buffered BU is present for the STA.

The protected frame subfield may be set to 1 if the frame body field contains information that has been processed by a cryptographic encapsulation algorithm. The +HTC subfield may indicate that the MAC frame contains an HT control field.

The duration/ID field of the MAC header may indicate various contents depending on the frame type and subtype and the QoS capabilities of the sending STA. For example, the duration/ID field, in control frames of the power save poll (PS-Poll) subtype, may carry an association identifier (AID) of the STA that sent (e.g., transmitted) the frame in the 14 least significant bits (LSB), with the 2 most significant bits (MSB) set to 1. The duration/ID field, in other frames sent by STAs, may contain a duration value (in microseconds) which is used by a recipient to update a network allocation vector (NAV). The NAV may be a counter that indicates to a STA an amount of time during which the STA must defer from accessing the shared medium.

Up to four address fields may be present in the MAC frame format. The address fields may be used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. The address 1 field may identify the intended receiver(s) of the frame, and the address 2 field, where present, may identify the transmitter of the frame.

The sequence control field may include two subfields, a sequence number subfield and a fragment number subfield. The sequence number subfield in data frames may indicate the sequence number of the MSDU (if not in an Aggregated MSDU (A-MSDU)) or A-MSDU. The sequence number subfield in management frames may indicate the sequence number of the frame. The fragment number subfield may indicate the number of each fragment of an MSDU or MMPDU. The fragment number may be set to 0 in the first or only fragment of an MSDU or MMPDU and may be incremented by one for each successive fragment of that MSDU or MMPDU. The fragment number may be set to 0 in a MAC protocol data unit (MPDU) containing an A-MSDU, or in an MPDU containing an MSDU or MMPDU that is not fragmented. The fragment number may remain constant in all retransmissions of the fragment.

The QoS control field may identify the traffic category (TC) or traffic stream (TS) to which the MAC frame belongs. The QoS control field may also indicate various other QoS related, A-MSDU related, and mesh-related information about the frame. This information may vary by frame type, frame subtype, and type of transmitting STA. The QoS control field may be present in all data frames in which the QoS subfield of the subtype subfield is equal to 1.

The HT control field may be present in QoS data, QoS null, and management frames as determined by the +HTC subfield of the frame control field. The frame body field may be a variable length field that contains information specific to individual frame types and subtypes. The frame body may include one or more MSDUs or MMPDUs. The minimum length of the frame body may be 0 octets.

The FCS field may contain a 32-bit Cyclic Redundancy Check (CRC) code. The FCS field value may be calculated over all of the fields of the MAC header and the frame body field.

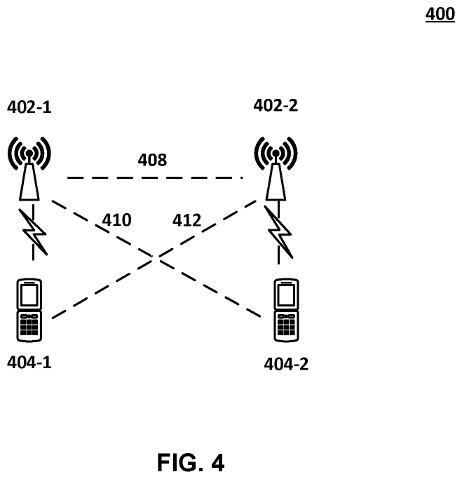

FIG. 4 shows an example network 400 that comprises a coordinated AP set. As shown in FIG. 4, the coordinated AP set may be comprised of two APs-AP 402-1 and AP 402-2. The coordinated AP set may be a subset of an established multi-AP group. At least one STA may be associated with each of APs 402-1 and 402-2. A STA 404-1 may be associated with AP 402-1, and a STA 404-2 may be associated with AP 402-2.

As described herein in FIG. 1, APs 402-1 and 402-2 may belong to the same ESS. In such a case, APs 402-1 and 402-2 may be connected by a DS to support ESS features. In addition, as part of a coordinated AP set, APs 402-1 and 402-2 may be connected by a backhaul. The backhaul is used to share information quickly between APs to support coordinated transmissions. The shared information may be channel state information or data to be sent (e.g., transmitted) to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 402-1 and 402-2 may act as a Master AP and the other as a Slave AP. The Master AP is the AP that is the owner of the TXOP. The Master AP may share frequency resources during the TXOP with the Slave AP. If/when there are more than two APs in the coordinated set, a Master AP may share its TXOP with only a subset of the coordinated AP set. The role of the Master AP may change over time. The Master AP role may be assigned to a specific AP for a duration of time. Similarly, the Slave AP role may be chosen by the Master AP dynamically or can be pre-assigned for a duration of time.

The APs may only do certain types of coordinated transmissions, for example, depending on the capability of APs in a coordinated AP set. In FIG. 4, if AP 402-1 supports JT and CSR while AP 402-2 supports CSR and CBF, for example, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 402-1 and AP 402-2 as shown in FIG. 4. Spatial reuse using CSR can be more stable than non-AP coordinated spatial reuse schemes such as OBSS PD-based SR and PSR-based SR. In example 400, APs 402-1 and 402-2 may perform a joint sounding operation in order to measure path loss (PL) on paths of network 400. The joint sounding operation may result in the measurement of PL 408 for the path between APs 402-1 and 402-2, path loss 410 for the path between AP 402-1 and STA 404-2, and path loss 412 for the path between AP 402-2 and STA 404-1. The measured path loss information may then be shared between APs 402-1 and 402-2 (e.g., using the backhaul) to allow for simultaneous transmissions by APs 402-1 and 402-2 to their associated STAs 404-1 and 404-2 respectively. Specifically, if/when APs 402-1 and/or 402-2 obtains a TXOP to become the Master AP. The Master AP may then send a CSR announcement frame to the other AP(s). The Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

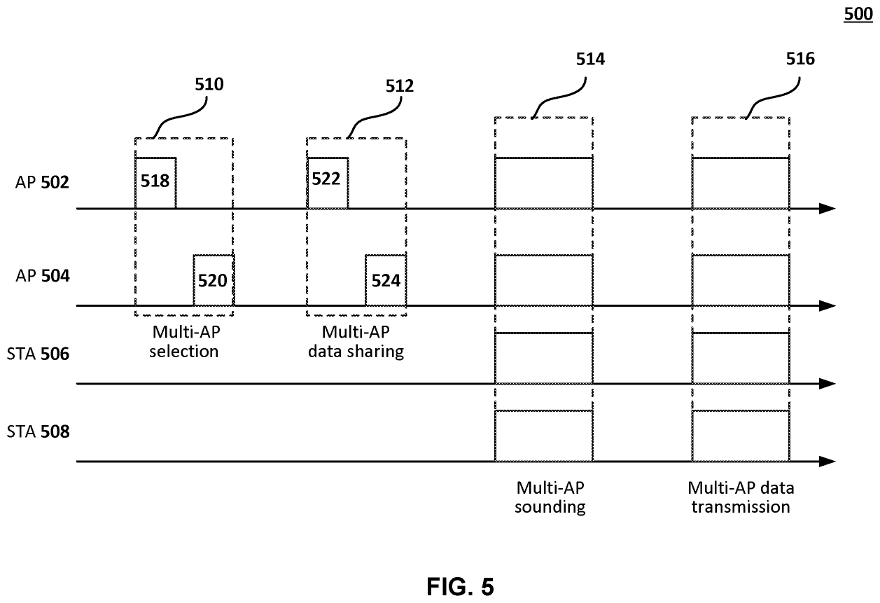

FIG. 5 shows an example 500 of a multi-AP operation procedure. In example 500, the multi-AP operation procedure is shown with respect to a multi-AP network that comprises APs 502 and 504 and STAs 506 and 508. APs 502 and 504 may form a multi-AP group. AP 502 may be the master AP and AP 504 may be a slave AP of the multi-AP group. AP 502 may obtain a TXOP making it the master AP of the multi-AP group. Alternatively, AP 502 may be designated as the master AP by a multi-AP controller.

As shown in FIG. 5, the multi-AP operation procedure may comprise a series of phases in time, each of which may contain a plurality of frame exchanges within the multi-AP network. Specifically, the multi-AP operation procedure may be comprised of a multi-AP selection phase 510, a multi-AP data sharing phase 512, a multi-AP sounding phase 514, and/or a multi-AP data transmission phase 516.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may comprise capability information, BSS information, and link quality information. The master AP may determine during a multi-AP selection phase the slave APs to be designated for a multi-AP transmission and a specific multi-AP transmission scheme to be used during the multi-AP transmission, based on the information provided by available slave APs.

The multi-AP selection phase 510 may be comprised of procedures for soliciting, selecting, and/or designating slave AP(s) for a multi-AP group by a master AP. As seen in FIG. 5, the multi-AP selection phase may comprise transmissions of frame 518 from AP 502 and frame 520 from AP 504. AP 502 may send (e.g., transmit) frame 518 to solicit information regarding the buffer status of AP 504. AP 504 may send (e.g., transmit) frame 520 to inform AP 502 of its and its associated STAs buffer status and/or whether it intends to join multi-AP operation. Multi-AP selection phase 510 may also be used to exchange information related to multi-AP operation, including BSS information of APs and link quality information between each AP and its associated STAs, for example. The BSS information of an AP may be comprised of a BSS ID of the BSS of the AP, identifiers and/or capabilities of STAs belonging to the BSS, information regarding sounding capabilities of the STAs, information regarding MIMO capabilities of the AP, etc. Link quality information may comprise received signal strength indicator (RSSI), signal-to-noise ratio (SNR), signal-to-interference-plus-noise-ratio (SINR), channel state information (CSI), channel quality indicator (CQI).

The multi-AP data sharing phase 512 may be comprised of procedures for sharing data frames to be sent by APs to associated STAs among the master AP and selected slave AP(s) via direct connections between APs. Phase 512 may be optional for some multi-AP data transmission schemes. Phase 512 may be required for JT/JR as data frames may be exchanged between APs before or after multi-AP data transmission phase 516.

The multi-AP data sharing phase 512 may be performed using a wired backhaul, an in-channel wireless backhaul, or an off-channel wireless backhaul. In some cases, multi-AP data sharing phase 512 may be performed over an in-channel backhaul (e.g., using the same wireless channel used to send/receive data to/from STAs). As shown in FIG. 5, in phase 512, AP 502 may send (e.g., transmit) a frame 522, which may be received by AP 504. Frame 522 may comprise MPDUs that AP 502 wishes to send (e.g., transmit) to associated STAs using a multi-AP operation. Similarly, AP 504 may send (e.g., transmit) a frame 524, which may be received by AP 502. Frame 524 may comprise MPDUs that AP 504 wishes to send (e.g., transmit) to associated STAs using a multi-AP operation.

The multi-AP sounding phase 514 may be comprised of procedures for multi-AP channel sounding, including channel estimation and feedback of channel estimates among the master AP, candidate slave AP(s), and associated STAs. Phase 514 may be optional for some multi-AP transmission schemes, such as COFDMA, CDTMA, and CSR. Phase 514 may be performed by the master AP to aid in resource unit allocation when orchestrating a COFDMA transmission.

The multi-AP data transmission phase 516 may comprise exchange of data frames between the master AP, slave AP(s), and their associated STAs based on multi-AP transmission scheme(s) determined by the master AP. Depending on the multi-AP transmission scheme(s) to be used, phase 516 may be comprised of optional synchronization between APs of the multi-AP group, before exchange of data frames between APs and STAs within the multi-AP group.

The order of phases 510, 512, 514 and 516 may be different than shown in FIG. 5. In COFDMA, phase 516 may occur immediately after phase 510, whereas, in JT/JR, phase 512 may occur after phase 510. Further, as mentioned herein, some phases may be optional and may or may not be present. Phase 614 may not be required for COFDMA but may be required for JT/JR.

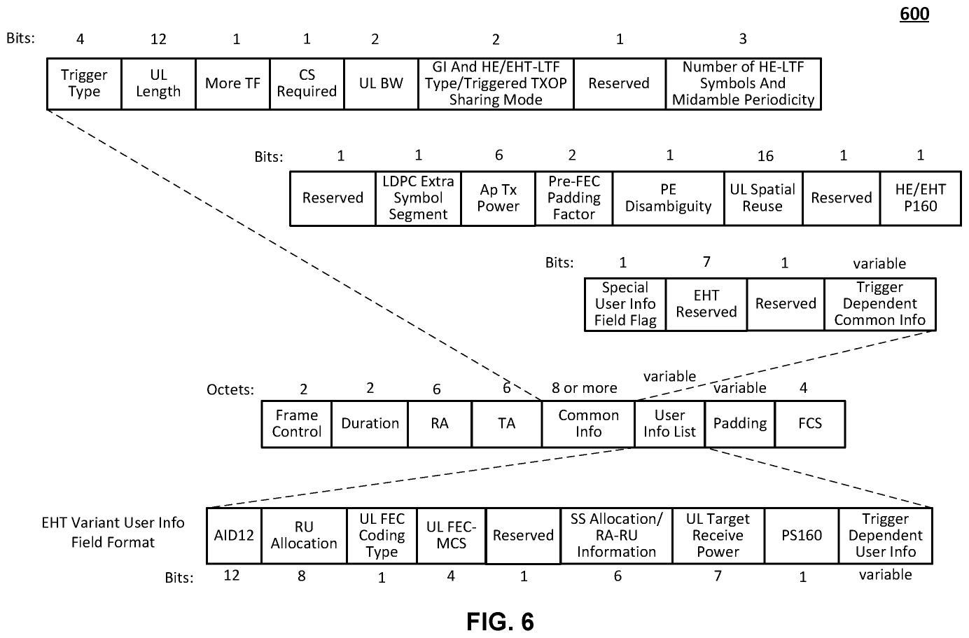

FIG. 6 shows an example format of a trigger frame 600. Trigger frame 600 may be used by an AP to allocate resources for and solicit one or more TB PPDU transmissions from one or more STAs. Trigger frame 600 may also carry other information required by a responding STA to send (e.g., transmit) a TB PPDU to the AP.

Trigger frame 600 as shown in FIG. 6 may include a Frame Control field, a Duration field, a receiver address (RA) field, a transmitter address (TA) field, a Common Info field, a User Info List field, a Padding field, and an FCS field. The Frame Control field may include the following subfields: protocol version, type, subtype, To DS, From DS, more fragments, retry, power management, more data, protected frame, and +HTC.

The Duration field may indicate various contents depending on frame type and subtype and the QoS capabilities of the sending STA. For example, the Duration field, in control frames of the power save poll (PS-Poll) subtype, may carry an association identifier (AID) of the STA that sent (e.g., transmitted) the frame in the 14 least significant bits (LSB), and the 2 most significant bits (MSB) are both set to 1. The Duration field, in other frames sent (e.g., transmitted) by STAs, may contain a duration value (in microseconds) which is used by a recipient to update a network allocation vector (NAV).

The RA field may be the address of the STA that is intended to receive the incoming transmission from the sending (e.g., transmitting) station. The TA field may be the address of the STA sending (e.g., transmitting) trigger frame 600 if trigger frame 600 is addressed to STAs that belong to a single BSS. The TA field may be the sent (e.g., transmitted) BSSID if trigger frame 600 is addressed to STAs from at least two different BSSs of the multiple BSSID set.

The Common Info field may specify a trigger frame type of trigger frame 600, a transmit power of trigger frame 600 in dBm, and several key parameters of a TB PPDU that is sent (e.g., transmitted) by a STA based on (e.g., in response to) trigger frame 600. The trigger frame type of a trigger frame used by an AP to receive QoS data using UL MU operation may be referred to as a basic trigger frame. A non-EHT non-AP HE STA may interpret the Common Info field as HE variant. A non-AP EHT STA may interpret the Common Info field as HE variant if B54 and B55 in the Common Info field are equal to 1; and may interpret the Common Info field as EHT variant otherwise. The HE variant Common Info field and the EHT variant Common Info field may use the same encoding method for the Trigger Type, UL Length, More TF, CS Required, LDPC Extra Symbol Segment, AP TX Power, Pre-FEC Padding Factor, PE Disambiguity, and Trigger Dependent Common Info subfields.

The User Info List field may contain zero or more User Info fields. There may be three variants for the User Info field, which are the Special User Info field, the EHT variant User Info field, and the HE variant User Info field.

The Special User Info field may be a User Info field that does not carry the user specific information and carries the extended common information not provided in the Common Info field. The Special User Info Field Flag subfield of the EHT variant Common Info field may be set to 0. The Special User Info Field Flag subfield of the EHT variant Common Info field may be set to 0, for example, if the Special User Info field is included in the Trigger frame. The Special User Info Field Flag subfield of the EHT variant Common Info field may be set to 1. The Special User Info Field Flag subfield of the EHT variant Common Info field may be set to 1, for example, if the Special User Info field is not included in the Trigger frame. The Special User Info field may be identified by an AID12 value of 2007 and may be optionally present in a Trigger frame that is generated by an EHT AP. The Special User Info field, if present, may be located immediately after the Common Info field of the Trigger frame and may carry information for the U-SIG field of a solicited EHT TB PPDU. The PHY Version Identifier subfield may indicate the PHY version of the solicited TB PPDU that is not an HE TB PPDU. The PHY Version Identifier subfield may be set to 0 for EHT. Other values from 1 to 7 may be reserved. The UL Bandwidth (BW) Extension subfield, together with the UL BW subfield in the Common Info field, may indicate the bandwidth of the solicited TB PPDU from the addressed EHT STA (i.e., the bandwidth in the U-SIG field of the EHT TB PPDU). The EHT Spatial Reuse n subfield may carry the values to be included in the corresponding Spatial Reuse n subfield in the U-SIG field of the EHT TB PPDU. The U-SIG Disregard And Validate subfield may carry the values to be included in the Disregard and Validate subfields of the U-SIG field of the solicited EHT TB PPDUs. The presence and length of the Trigger Dependent User Info subfield in the Special User Info field may depend on the variant of the Trigger frame.

The EHT variant User Info field may contain a User Info field per STA addressed in trigger frame 600. The per STA User Info field may include, among others, an AID12 subfield, an RU Allocation subfield, a UL FEC Coding Type subfield, a UL EHT-MCS subfield, a Reserved subfield, a Spatial Stream (SS) Allocation/RA-RU information subfield, a UL Target Receive Power subfield, and a Power Save (PS) 160 subfield to be used by a STA in a TB PPDU sent (e.g., transmitted) based on (e.g., in response to) trigger frame 600, and a Trigger Dependent User Info subfield. The RU Allocation subfield in an EHT variant User Info field in a Trigger frame that is not an MU-RTS Trigger frame, along with the UL BW subfield in the Common Info field, the UL BW Extension subfield in the Special User Info field, and the PS160 subfield in the EHT variant User Info field, may identify the size and the location of the RU or MRU. The values of PS160 subfield and B0 of RU Allocation subfield may indicate the 80 MHz frequency subblock in which the RU or MRU is located for 26-tone RU, 52-tone RU, 106-tone RU, 242-tone RU, 484-tone RU, 996-tone RU, 52+26-tone RU, and 106+26-tone RU. The values of PS160 subfield may indicate the 160 MHz segment in which the RU or MRU is located for 2□996-tone RU, 996+484-tone MRU, and 996+484+242-tone MRU. The UL FEC Coding Type subfield of the User Info field may indicate the code type of the solicited EHT TB PPDU. The UL FEC Coding Type subfield may be set to 0 to indicate BCC and set to 1 to indicate LDPC. The UL EHT-MCS subfield of the User Info field may indicate the EHT-MCS of the solicited EHT TB PPDU. The SS Allocation subfield of the EHT variant User Info field may indicate the spatial streams of the solicited EHT TB PPDU. The UL Target Receive Power subfield may indicate the expected receive signal power, measured at the AP's antenna connector and averaged over the antennas, for the EHT portion of the EHT TB PPDU sent (e.g., transmitted) on the assigned RU. The Trigger Dependent User Info subfield may be used by an AP to specify a preferred access category (AC) per STA. The preferred AC may set the minimum priority AC traffic that can be sent by a participating STA. The AP may determine the list of participating STAs, along with the BW, MCS, RU allocation, SS allocation, Tx power, preferred AC, and maximum duration of the TB PPDU per participating STA. The RA-RU Information subfield may be reserved in the EHT variant User Info field.

The Padding field may be optionally present in management frame 400 to extend the frame length to give recipient STAs enough time to prepare a response for transmission one SIFS after the frame is received. The Padding field, if present, may be at least two octets in length and is set to all 1 s. The FCS field may be used by a STA to validate a received frame and to interpret certain fields from the MAC headers of a frame.

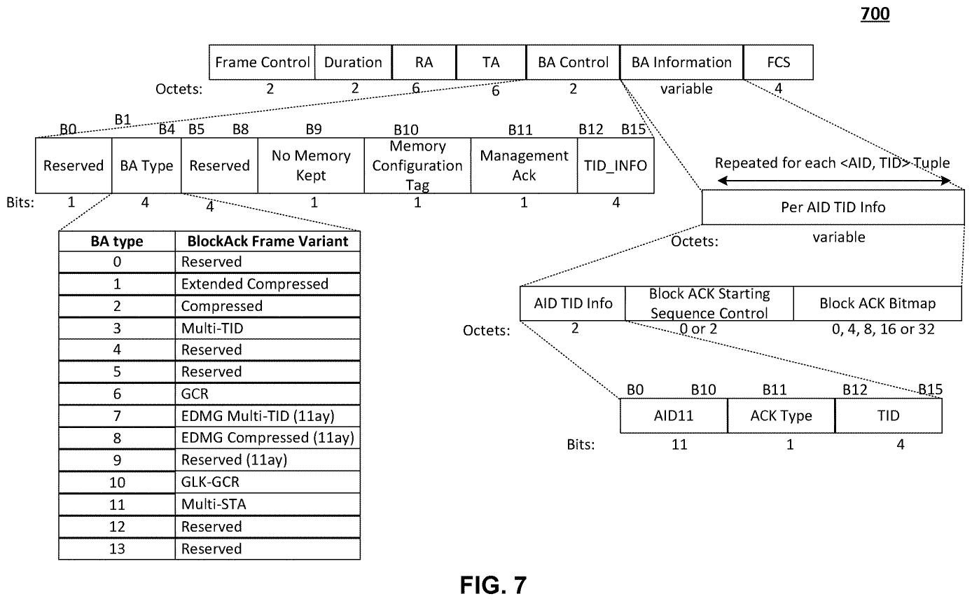

FIG. 7 shows an example BlockAck (BA) frame. BA frame 700 may correspond to a multi-STA BlockAck (e.g., multi-STA BA) frame as defined in the IEEE 802.11ax/be standard amendment. BA frame 700 may be used by an AP to acknowledge one or more successfully received TB PPDU transmissions from one or more STAs. BA frame 700 may carry other information that may be required by a responding STA to send (e.g., transmit) a TB PPDU to the AP. According to IEEE 802.11 ax/be standard amendments, a multi-STA BA frame may be supported, for example, if either UL MU or multi-TID A-MPDU operation may be supported. The multi-STA BA may acknowledge MPDUs carried in a TB PPDU or in multi-STA multi-TID, multi-STA single-TID, or single-STA multi-TID A-MPDUs.

As described with respect to FIG. 7, BA frame 700 may include a Frame Control field, a Duration field, a RA field, a TA field, a block acknowledgment (BA) control field, a BA information field, and an FCS field. The Frame Control and Duration fields may be similar to corresponding fields described herein with respect to trigger frame 600 shown in FIG. 6. The RA field may include the address of the STA intended to receive BA frame 700. The TA field may include the address of the STA transmitting BA frame 700 if BA frame 700 is addressed to STAs that belong to a single BSS.

The BA Control field may include the following subfields: reserved, BA type, reserved, no memory kept, memory configuration tag, management ACK, and TID_INFO. As described with respect to FIG. 7, the BA type subfield may indicate BA frame variants. The BA type subfield may comprise four bits. For example, BA type 11 (e.g., 1011 in binary) may represent a multi-STA BA variant. The No Memory Kept, Memory Configuration Tag, and the Management ACK subfields may be reserved for 802.11ay standard amendments. The TID_INFO subfield may be reserved.

The BA Information field may be sent as an acknowledgment to QoS Data frames that may solicit a Multi-STA BA frame response. The BA information field may include a Per AID TID Info subfield that may comprise a variable number of octets. The Per AID TID Info subfield may include the following subfields: AID TID Info (2 octets), Block Ack Starting Sequence Control (0 or 2 octets), and Block Ack Bitmap (e.g., 0, 4, 9, 19, 32, 64, or 128 octets).

The AID TID Info subfield may contain three subfields: AID11, ACK Type, and TID. The AID 11 subfield may carry the 11 LSBs of the AID of the STA for which the Per AID TID Info subfield may be intended. The ACK type and the TID subfields may provide different acknowledgment contexts of the multi-STA BA frame. The Block Ack Starting Sequence Control subfield of the Per AID TID Info may contain the sequence number of the first MSDU or A-MSDU for which the multi-STA BA frame may be sent. The Block Ack Bitmap subfield of the BA Information field may be used to indicate the received status of A-MSDUs for the STA. The FCS field may be used by a STA to validate a received frame and/or to interpret certain fields from the MAC headers of a frame.

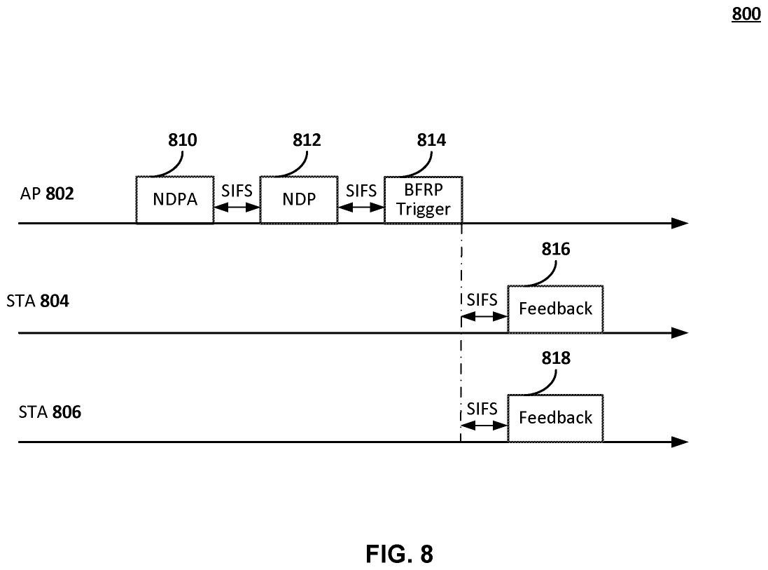

FIG. 8 shows an example 800 of a trigger based (TB) sounding sequence. Example 800, as shown in FIG. 8, may include an AP 802 and STAs 804 and 806. Example 800 may begin with AP 802 initiating the TB sounding sequence by sending (e.g., transmitting) an NDPA frame 810 to STAs 804 and 806. NDPA frame 810 may be an example of NDPA frame 900 described herein. AP 802 may be an EHT beamformer. NDPA frame 810 may include two STA Info fields with AID11 subfields set respectively to the AIDs of STAs 804 and 806. An RA field of NDPA frame 810 may be set to a broadcast address. Example 800 is discussed as an EHT beamformer, and this is merely an example and not limited. Example 800, and other examples described throughout, may use UHR beamforming by replacing EHT frame(s) with corresponding UHR frame(s).

NDPA frame 810 may solicit SU feedback, MU feedback, or CQI feedback from STAs 804 and 806. SU feedback may comprise a compressed beamforming report. The compressed beamforming report may comprise an average SNR of each spatial stream and compressed beamforming feedback matrices for use by AP 802 to determine steering matrices for explicit feedback beamforming to STAs 804 and 806. MU feedback may comprise a compressed beamforming report and an MU exclusive beamforming report. The MU exclusive beamforming report may comprise explicit feedback in the form of delta SNRs. CQI feedback may comprise a CQI report. The CQI report may comprise per-RU average SNRs of each spatial stream. A per-RU average SNR may comprise an arithmetic mean of the SNR in decibels over the subcarriers of a 26-tone RU for which feedback is being requested. AP 802 may be an EHT beamformer. NDPA frame 810 may include a first STA Info field and a second STA Info field. The AID11 subfield of the first STA Info field may be set to the AID of STA 804. The AID11 subfield of the second STA Info field may be set to the AID of STA 806.

A SIFS after sending (e.g., transmitting) NDPA frame 810, AP 802 may send (e.g., transmit) an NDP 812. NDP 812 may be an EHT sounding NDP. A SIFS after sending (e.g., transmitting) NDP 812, AP 802 may send (e.g., transmit) a trigger frame 814. Trigger frame 814 may be a beamforming report poll frame (BFRP) frame. Trigger frame 814 may address STAs 804 and 806 as beamformees. A SIFS after receiving trigger frame 814, STAs 804 and 806 may send (e.g., transmit) respective feedback frames 816 and 818. Feedback frames 816 and 818 may each comprise an EHT compressed beamforming/CQI frame and may be carried in a TB PPDU. The EHT compressed beamforming/CQI frame may comprise one or more beamforming reports. For example, the beamforming report may comprise the compressed beamforming report, the MU exclusive beamforming report, or the CQI report.

AP 802 may send (e.g., transmit) additional trigger frames in the same TXOP to solicit feedback frames from EHT beamformees not addressed in trigger frame 814. AP 802 may not send (e.g., transmit) a trigger frame that solicits a STA identified in NDPA frame 810 unless the trigger frame is in the same TXOP as NDPA frame 810.

Example 800 may represent an EHT TB sounding sequence. AP 802 may represent an EHT beamformer. STAs 804 and 806 may represent EHT beamformees. NDPA frame 810 may be an EHT NDPA.

AP 802, as an EHT beamformer, may not send (e.g., transmit) a BFRP Trigger frame that solicits a STA (e.g., STA 804 or STA 806) identified in NDPA frame 810 unless the BFRP Trigger frame is in the same TXOP as the EHT TB sounding sequence. The STAs identified in NDPA frame 810 may be the same as the STAs identified in trigger frame(s) in the same TXOP.

AP 802, as an EHT beamformer, may set all the bits of a “Feedback Segment Retransmission Bitmap” field of (e.g., BFRP) trigger frame 814 to 1 s. (BFRP) trigger frame 814 may contain one or more User Info fields, each of which identifies an EHT beamformee (e.g., STA 804 or STA 806).

A STA Info field in NDPA frame 810 may indicate the subcarrier grouping, Ng, codebook size, and the quantity/number of columns, Nc, to be used by the EHT beamformee identified by the STA Info field for the generation of the SU or MU feedback. The STA Info field in NDPA frame 810 may indicate the subcarrier grouping, Ng, codebook size, and the quantity/number of columns, Nc, to be used by the EHT beamformee identified by the STA Info field for the generation of the SU or MU feedback, for example, if NDPA frame 810 solicits SU or MU feedback. A STA Info field in NDPA frame 900 may indicate the Nc to be used by the EHT beamformee identified by the STA Info field for the generation of the CQI feedback. The STA Info field in NDPA frame 900 may indicate the Nc to be used by the EHT beamformee identified by the STA Info field for the generation of the CQI feedback, for example, if NDPA frame 810 solicits CQI feedback,

STA 804/806 may generate an EHT CQI report for CQI feedback with Nc determined by AP 802. STA 804/806 may generate an EHT CQI report for CQI feedback with Nc determined by AP 802, for example, if STA 804 (or STA 806) as an EHT beamformee receives NDPA frame 810 soliciting CQI feedback.

STA 804 (or STA 806) may generate an EHT compressed beamforming report using the feedback type, Ng, codebook size, and Nc indicated in the STA Info field. STA 804 (or STA 806) may generate an EHT compressed beamforming report using the feedback type, Ng, codebook size, and Nc indicated in the STA Info field, for example, if STA 804 (or STA 806) as an EHT beamformee may receive NDPA frame 810 with a STA Info field identifying STA 804 (or STA 806) soliciting SU or MU feedback.

STA 804 (or STA 806) may send (e.g., transmit) an EHT TB PPDU containing the EHT compressed beamforming/CQI report. STA 804 (or STA 806) may send (e.g., transmit) an EHT TB PPDU containing the EHT compressed beamforming/CQI report, for example, if STA 804 (or STA 806) as an EHT beamformee may receive (BFRP) trigger frame 814 with a matching User Info field. AP 802 may send (e.g., transmit) NDPA frame 810 with a TA field set to a sent (e.g., transmitted) BSSID, and STA 804 (or STA 806) may be a non-AP STA associated with an AP corresponding to a non-sent (e.g., transmitted) BSSID that supports receiving control frames with TA fields set to the sent (e.g., transmitted) BSSID. The EHT compressed beamforming/CQI report sent by STA 804 (or STA 806) in response may include an RA field set to a MAC address of AP 802.

The EHT compressed beamforming/CQI report may be split into up to eight feedback segments. The EHT compressed beamforming/CQI report may be split into up to eight feedback segments, for example, if an EHT compressed beamforming/CQI report solicited by AP 802 would result in a feedback frame (e.g., 816 or 818) that exceeds 11454 octets in length. Each feedback segment may be included in a separate feedback frame and may contain successive portions of the EHT compressed beamforming/CQI report. Feedback segments may be of equal length except the last feedback segment, which may be shorter. Each feedback frame that includes a feedback segment that is not the last feedback segment may have a length of 11454 octets. Each feedback segment may be identified by the value of the “Remaining Feedback Segments” subfield and the “First Feedback Segment” subfield in an EHT MIMO Control field of the feedback frame that includes the feedback segment. The other non-reserved subfields of the EHT MIMO Control field may be the same for all feedback segments. Feedback frames may be sent in an A-MPDU contained in a single PPDU and may be included in the A-MPDU in descending order based on values of the “Remaining Feedback Segments” subfield.

AP 802 may solicit all possible feedback segments by setting to 1 all of the bits of the “Feedback Segment Retransmission Bitmap” subfield of the User Info field (of trigger frame 824) identifying the EHT beamformee. AP 802 may solicit all possible feedback segments by setting to 1 all of the bits of the “Feedback Segment Retransmission Bitmap” subfield of the User Info field (of trigger frame 824) identifying the EHT beamformee, for example, if AP 802 as an EHT beamformer sends (e.g., transmits) (BFRP) trigger frame 814 to retrieve an EHT compressed beamforming/CQI report from an EHT beamformee (e.g., STA 804 or STA 806),

AP 802 may not send (e.g., transmit) a further BFRP Trigger frame to request retransmission of the feedback segments. Instead, AP 802 may repeat the entire EHT sounding sequence. AP 802 may not send (e.g., transmit) a further BFRP Trigger frame to request retransmission of the feedback segments. Instead, AP 802 may repeat the entire EHT sounding sequence, for example, if AP 802 as an EHT beamformer fails to receive some or all of the feedback segments of the EHT compressed beamforming/CQI report from an EHT beamformee (e.g., STA 804 or STA 806).

Precorrection of time, frequency, sampling clock, and power (in the case of a High Efficiency (HE) TB PPDU or extremely high throughput (EHT) TB PPDU) by STAs 804 and 806 may be necessary to mitigate synchronization and interference issues at AP 802. Precorrection of time, frequency, sampling clock, and power (in the case of a High Efficiency (HE) TB PPDU or extremely high throughput (EHT) TB PPDU) by STAs 804 and 806 may be necessary to mitigate synchronization and interference issues at AP 802, for example, if feedback frames 816 and 818 (e.g., TB PPDUs carrying feedback frames 816 and 818) are sent (e.g., transmitted) by STAs 804 and 806 simultaneously based on (e.g., in response to) trigger frame 814. Specifically, frequency and sampling clock precorrections may be needed to prevent inter-carrier interference. Power precorrection may be necessary to control interference between the TB PPDUs carrying feedback frames 816 and 818.

Trigger frame 814 may include in a User Info field an uplink (UL) Target Receive Power subfield that indicates whether a STA among STAs 804 and 806 is to send (e.g., transmit) TB PPDUs carrying feedback frames 816 and/or 818 at a maximum transmit power. The maximum transmit power may correspond to the STA's maximum transmit power for the assigned HE-MCS. The respective STA may send (e.g., transmit) the TB PPDU carrying feedback frames 816 or 818 at the maximum transmit power The respective STA may send (e.g., transmit) the TB PPDU carrying feedback frames 816 or 818 at the maximum transmit power, for example, if the UL Target Receive Power subfield indicates that the maximum transmit power is to be used. Otherwise, the STA may calculate the transmit power,

$${Tx}_{pwr}^{STA} ,$$

of the TB PPDU for the assigned HE-MCS using the equation:

$${Tx}_{pwr}^{STA} = {PL}_{DL} + Target {Rx}_{pwr}$$

where PL_{DL} is the downlink pathloss and TargetRx_{pwr} is the expected receive signal power, in units of dBm, as indicated by the UL Target Receive Power subfield in the User Info field of trigger frame 814. The respective STA may take into account the beamforming gain in calculating the transmit power. The respective STA may take into account the beamforming gain in calculating the transmit power, for example, if STA 804 and/or STA 806 applies beamforming to the TB PPDU carrying feedback frame 816 and/or 818.

STA 804 and/or STA 806 may compute PL_{DL} using the equation:

$${PL}_{DL} = {Tx}_{pwr}^{AP} - {Rx}_{pwr}$$

where

$${Tx}_{pwr}^{AP}$$

is the AP's transmit power, in units of dBm/20 MHz, as indicated by an AP Tx Power subfield of a Common Info field of trigger frame 814 and Rx_{pwr} is the receive signal power, in units of dBm/20 MHz, of trigger frame 814 at an antenna connector of the STA. Rx_{pwr} may be an average of the receive signal power over the antennas on which the average PL_{DL} is being computed.

An AP and an associated STA tuned to the same carrier frequency may have errors in their generated carrier frequencies in reference to the ideal carrier frequency, due to the finite accuracy of clock generating circuits of an AP and a STA. The AP may observe a baseband signal whose center frequency has an offset (i.e. carrier frequency offset or CFO) from the DC subcarrier. The AP may observe a baseband signal whose center frequency has an offset (i.e. carrier frequency offset or CFO) from the DC subcarrier, for example, if an AP receives a TB PPDU as in example 800. An AP receiving the symbols of a TB PPDU sampled using its own clock may observe that the TB PPDU signal is generated at a clock offset (i.e. symbol clock offset or SCO) from its own sampling clock. Both SCO and CFO may result in receive errors when not properly mitigated. A STA may compensate for carrier frequency offset (CFO) error and symbol clock error with respect to trigger frame 814 in order to limit the effects of CFO and SCO. A STA may compensate for carrier frequency offset (CFO) error and symbol clock error with respect to trigger frame 814 in order to limit the effects of CFO and SCO, for example, if the TB PPDU carrying feedback frame 816 and/or 818 is a TB PPDU or a non-HT or non-HT duplicate PPDU with the TXVECTOR parameter TRIGGER RESPONDING set to true. The absolute value of residual CFO error with respect to trigger frame 814 after compensation may not exceed the following levels when measured at the 10% point of a complementary cumulative distribution function (CCDF) of CFO errors in Additive White Gaussian Noise (AWGN) at a received power of-60 dBm in the primary 20 MHz channel: 350 Hz for the data subcarriers of a TB PPDU; 2 kHz for a non-HT PPDU or non-HT duplicate PPDU. The residual CFO error measurement on an HE TB PPDU may be made after the HE-SIG-A field. The residual CFO error measurement on an EHT TB PPDU shall be made after the U-SIG field. The residual CFO error measurement on a non-HT or non-HT duplicate PPDU may be made after the L-STF field. The symbol clock error may be compensated by the same ppm amount as the CFO error.

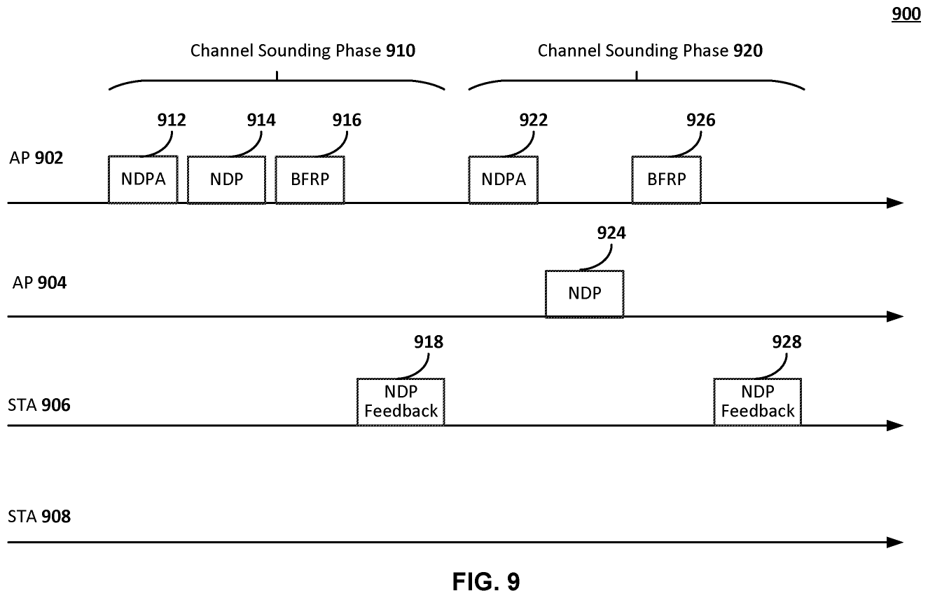

FIG. 9 shows an example 900 of sequential NDP sounding. Example 900 may include two APs 902 and 904. Example 900 may further include a STA 906 associated with AP 902 and a STA 908 associated with AP 904. APs 902 and 904 may form a multi-AP group. AP 902 in example 900 may wish to perform a coordinated beamforming procedure or coordinated spatial reuse procedure with AP 904. AP 902 may be the AP coordinating/controlling the coordinated beamforming procedure. AP 902 may be referred to as a master/sharing AP, and AP 904 may be referred to as a slave/shared AP. Example 900 may include a channel sounding phase 910 and a channel sounding phase 920. AP 902 and/or AP 904 may perform channel sounding phase 910 first followed by channel sounding phase 920, or perform channel sounding phase 920 first followed by channel sounding phase 910. Example 900 may be performed by AP 902 and AP 904 periodically or as necessary, to collect the necessary channel feedback for a coordinated beamforming or coordinated spatial reuse operation.

AP 902 in channel sounding phase 910 may use TB sounding (e.g., as discussed herein in relation to example 800 shown in FIG. 8) to acquire CSI of a channel between AP 902 and STA 906. For example, AP 902 may send (e.g., transmit) an NDPA frame 912. NDPA frame 912 may be an example of NDPA frame 900 described herein and may be used for TB sounding like NDPA frame 810 shown in FIG. 8. NDPA frame 912 may be addressed to STAs associated with sending (e.g., transmitting) AP 902 (e.g., NDPA frame 912 is addressed to STA 906 associated with AP 902).

AP 902 may send (e.g., transmit) an NDP 914 after sending (e.g., transmitting) NDPA frame 912. NDP 914 may be an EHT sounding NDP, like NDP 812 described in example 800. STA 906 may determine an estimate of the channel (CSI) between AP 902 and STA 906 based on NDP 914. AP 902 may send (e.g., transmit) a trigger frame 916 after sending (e.g., transmitting) NDP 99. Trigger frame 916 may be a BFRP frame, corresponding to trigger frame 814 in example 800, and may address STA 906 as a beamformee. Example 900, like example 800, may be discussed as an EHT beamformer. Example 900, and other EHT examples described throughout, may use UHR beamforming by replacing EHT frame(s) with corresponding UHR frame(s).

STA 906 may send (e.g., transmit) a feedback frame 918 after receiving trigger frame 916. Feedback frame 918, like feedback frames 816 and 818 in example 800, may be carried in a TB PPDU, and may include one or more beamforming reports with CSI information for the channel between STA 906 and AP 902 (e.g., a compressed beamforming report, an MU exclusive beamforming report, or a CQI report). AP 902 may receive feedback frame 918, and may use the CSI information for the channel between STA 906 and AP 902 for coordinated beamforming with AP 904 to STAs 906 and 908. In the coordinated beamforming, AP 902 may send (e.g., transmit) a beamformed transmission to STA 906 (with nulling towards STA 908) and AP 904 may send (e.g., transmit) a beamformed transmission to STA 908 (with nulling towards STA 906).

During channel sounding phase 920, AP 902 and AP 904 may use TB sounding to acquire CSI of a channel between AP 904 and STA 906. For example, AP 902 may send (e.g., transmit) an NDPA frame 922. NDPA frame 922 may be an example of NDPA frame 900 described herein, and may be used for TB sounding like NDPA frame 810 shown in FIG. 8.

NDPA frame 922, as in channel sounding phase 910, may be addressed to STAs associated with AP 902 (e.g., STA 906). AP 904 may also receive NDPA frame 922. AP 904 may send (e.g., transmit) an NDP 924 (e.g., to STA 906 or as a broadcast), after receiving NDPA frame 922 from AP 902. AP 902 and AP 904 may negotiate in advance that AP 904 uses NDPA frames from AP 902 to trigger transmission of an NDP from AP 904 to STA 906 (e.g., an overlapping basic service set (OBSS) STA for AP 904). An OBSS STA for an AP may be a STA that is a member of a BSS operating on the same channel as the AP's BSS and within (either partly or wholly) the AP's basic service area (BSA). AP 902 may include an indication in NDPA frame 922 that AP 904 should trigger transmission of NDP 924 from AP 904 to STA 906.

NDP 924 may be an EHT sounding NDP, like NDP 914 and NDP 812 described in example 800. STA 906 may determine an estimate of the channel (CSI) between AP 904 and STA 906 based on NDP 924. AP 902 may send (e.g., transmit) a trigger frame 926 after AP 904 sends (e.g., transmits) NDP 924. Trigger frame 926, like trigger frame 916, may be a BFRP frame, corresponding to trigger frame 814 in example 800, and may address STA 906 as a beamformee.

STA 906 may send (e.g., transmit) a feedback frame 928 after receiving trigger frame 926. Feedback frame 928, like feedback frame 918 and feedback frames 816 and 818 in example 800, may be carried in a TB PPDU, and may include one or more beamforming reports. The beamforming reports, based on STA 906 receiving NDP 924 from AP 904, may include CSI information for the channel between STA 906 and AP 904 (e.g., a compressed beamforming report, an MU exclusive beamforming report, or a CQI report). AP 904 may receive feedback frame 928 from STA 906 and may use the CSI information for the channel between STA 906 and AP 904 for coordinated beamforming with AP 902 to STAs 906 and 908.

AP 904 may repeat the same procedure for its associated STAs (e.g., STA 908), after AP 902 completes channel sounding phase 910 and channel sounding phase 920 for its associated STAs (e.g., STA 906). For example, AP 904 may use a third and fourth channel sounding phase (not pictured), analogous to the shown channel sounding phases 910 and 920, to acquire CSI for a channel between AP 904 and STA 908, and for a channel between AP 902 and STA 908. AP 902 and AP 904 may use this CSI information for the coordinated beamforming to STAs 906 and 908.

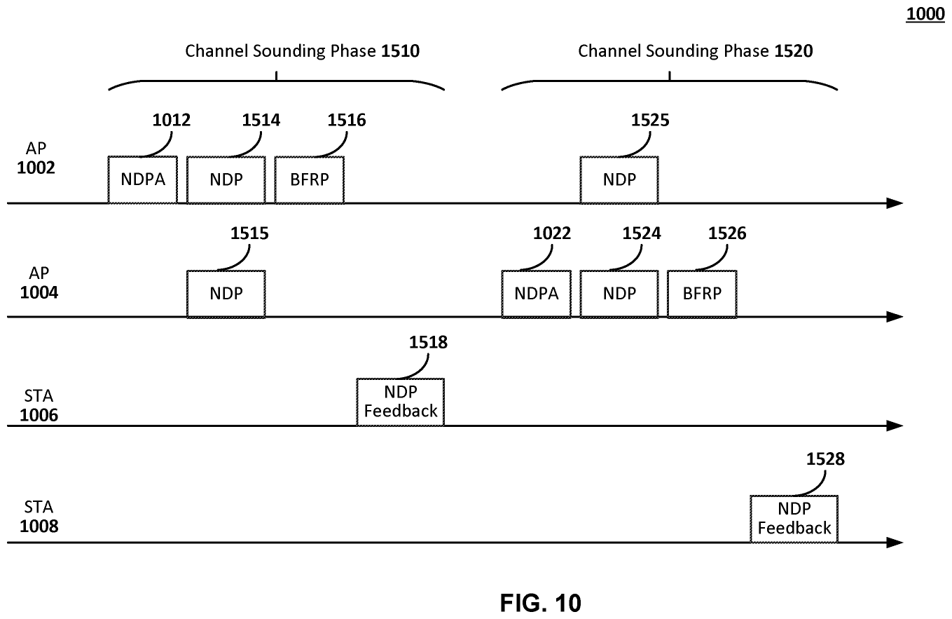

FIG. 10 shows an example 1000 of joint NDP sounding. Example 1000 may include two APs 1002 and 1004. Example 1000 may further include a STA 1006 associated with AP 1002, and a STA 1008 associated with AP 1004. APs 1002 and 1004 may form a multi-AP group. AP 1002 in example 1000 may wish to perform a coordinated beamforming procedure or coordinated spatial reuse procedure with AP 1004. AP 1002 may be the AP coordinating/controlling the coordinated beamforming procedure. AP 1002 may be referred to as a master/sharing AP, and AP 1004 may be referred to as a slave/shared AP. Example 1000 may be performed by AP 1002 and AP 1004 periodically or as necessary, to collect the necessary channel feedback for a coordinated beamforming or coordinated spatial reuse operation.

Example 1000 as shown may include a channel sounding phase 1010 and a channel sounding phase 1020. AP 1002 and AP 1004 in channel sounding phase 1010 may perform both sounding phases discussed in example 1400, simultaneously, for STA 1006. AP 1002 and AP 1004 in channel sounding phase 1020 may perform both sounding phases discussed in example 1400, simultaneously, for STA 1008.

AP 1002 in channel sounding phase 1010 may send (e.g., transmit) an NDPA frame 1012. NDPA frame 1012 may be an example of NDPA frame 900 described herein, and may be used for TB sounding like NDPA frame 810 shown in FIG. 8. NDPA frame 1012 may be addressed to STAs associated with sending (e.g., transmitting) AP 1002 (e.g., NDPA frame 1012 is addressed to STA 1006 associated with AP 1002).

AP 1004 may receive NDPA frame 1012. AP 1002 and AP 1004 may negotiate in advance that AP 1004 uses NDPA frames from AP 1002 to trigger transmission of an NDP from AP 1004 to STA 1006. For example, AP 1002 may include an indication in NDPA frame 1012 that AP 1004 may trigger transmission of NDP 1015 from AP 1004 to STA 1006 (e.g., after a SIFS duration). AP 1002 may send (e.g., transmit) NDP 1014 to STA 1006, simultaneous with AP 1004 sending (e.g., transmitting) NDP 1015 to STA 1006. AP 1002 may send (e.g., transmit) NDP 1014 after a SIFS duration following transmission of NDPA frame 1012.

NDP 1014 and NDP 1015 may be sent (e.g., transmitted) orthogonally in the code domain to avoid collision. For example, NDP 1014 and NDP 1015 may use orthogonal rows of a P matrix used in MIMO LTFs. The use orthogonal rows of the P matrix may allow STA 1006 to simultaneously estimate CSI for a channel between STA 1006 and AP 1002 (e.g., based on NDP 1014), and for a channel between STA 1006 and AP 1004 (e.g., based on NDP 1015).

AP 1002 may send (e.g., transmit) a trigger frame 1016 after sending (e.g., transmitting) NDP 1014. Trigger frame 1016 may be a BFRP frame, corresponding to trigger frame 814 in example 800, and may address STA 1006 as a beamformee.

STA 1006 may send (e.g., transmit) a feedback frame 1018 after receiving trigger frame 1016. Feedback frame 1018, like feedback frames 816 and 818 in example 800, may be carried in a TB PPDU, and may include one or more beamforming reports with CSI information (e.g., a compressed beamforming report, an MU exclusive beamforming report, or a CQI report). Feedback frame 1018 may include CSI information for both the channel between STA 1006 and AP 1002 (e.g., based on NDP 1014), and for the channel between STA 1006 and AP 1004 (e.g., based on NDP 1015). The feedback included in feedback frame 1018 may be based on large V-based feedback where the eigen-vectors span the antennas across both AP 1002 and AP 1004.

AP 1002 may receive feedback frame 1018 from STA 1006, and may use the CSI information for the channel between STA 1006 and AP 1002 for coordinated beamforming with AP 1004 to STAs 1006 and 1008. Similarly, AP 1004 may also receive feedback frame 1018 from STA 1006, and may use the CSI information for the channel between STA 1006 and AP 1004 for the coordinated beamforming with AP 1002 to STAs 1006 and 1008. AP 1002 in the coordinated beamforming may send (e.g., transmit) a beamformed transmission to STA 1006 (with nulling towards STA 1008), and AP 1004 may send (e.g., transmit) a beamformed transmission to STA 1008 (with nulling towards STA 1006).

Channel sounding phase 1010 may show joint sounding for STA 1006 associated with AP 1002. Channel sounding phase 1020 may correspond to channel sounding phase 1010, but STA 1008 may be associated with AP 1004, and STA 1006 may be associated with AP 1002. AP 1004 may send (e.g., transmit) an NDPA 1022, and AP 1002 and AP 1004 may simultaneously send (e.g., transmit) an NDP 1024 and an NDP 1025 (e.g., using orthogonal transmission in the code domain to avoid collision, as discussed herein for NDP 1014 and NDP 1015 in channel sounding phase 1010). AP 1004 may send (e.g., transmit) a trigger frame 1026 (e.g., a BFRP frame, like trigger frame 1016) to STA 1008.

STA 1008 may send (e.g., transmit) a feedback frame 1028 with CSI information for both the channel between STA 1008 and AP 1004 (e.g., based on NDP 1024), and for the channel between STA 1008 and AP 1002 (e.g., based on NDP 1025), after receiving trigger frame 1026. AP 1004 may receive feedback frame 1028, and may use the CSI information for the channel between STA 1008 and AP 1004 for coordinated beamforming with AP 1002 to STAs 1006 and 1008. AP 1002 may similarly receive feedback frame 1028 from STA 1008, and may use the CSI information for the channel between STA 1008 and AP 1002 for the coordinated beamforming to STAs 1006 and 1008.

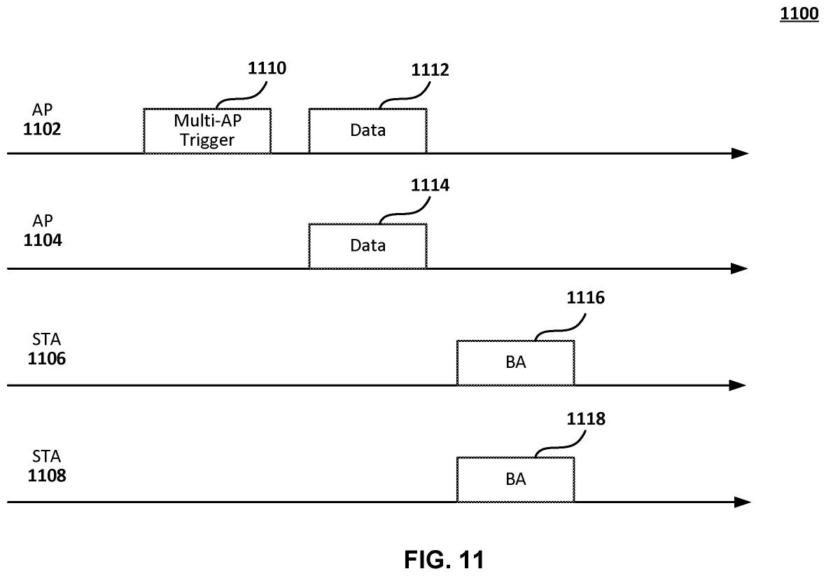

FIG. 11 shows an example 1100 of a multi-AP downlink data transmission phase. Example 1100 may be an example of multi-AP data transmission phase 516. Example 1100 as shown in FIG. 11 may include a master AP 1102 and a slave AP 1104 of a multi-AP group. Example 1100 may further include a STA 1106 associated with AP 1102, and a STA 1108 associated with AP 1104.

Example 1100 as shown in FIG. 11 may include frame exchanges to enable master AP 1102 to coordinate with slave AP 1104 to perform specific multi-AP transmission schemes with their associated STAs 1106 and 1108 respectively. The multi-AP transmission schemes may include COFDMA, CTDMA, CSR, CBF, JT/JR, or a combination of two or more of the aforementioned schemes.

Master AP 1102 as shown in FIG. 11 may begin example 1100 by sending (e.g., transmitting) a frame 1110 to AP 1104. Frame 1110 may include information related to AP 1104 (e.g., an identifier of AP 1104), synchronization information, information related to a specific multi-AP transmission scheme to be used, and/or information related to a resource unit (RU) for use by AP 1104 to acknowledge frame 1110. Frame 1110 may comprise a control frame. For example, frame 1110 may comprise a multi-AP trigger frame.

Slave AP 1104 may receive frame 1110 and may use the synchronization information to synchronize with master AP 1102. APs 1102 and 1104 may subsequently perform data transmission to their associated STAs 1106 and 1108 respectively. AP 1102 may send (e.g., transmit) a data frame 1112 to its associated STA 1106, and AP 1104 may send (e.g., transmit) a data frame 1114 to its associated STA 1108. APs 1102 and 1104 may send (e.g., transmit) frames 1112 and 1114 respectively to STAs in different BSSs, depending on the multi-AP transmission scheme being used. AP 1102 may send (e.g., transmit) frame 1112 to STA 1108 associated with slave AP 1104, and AP 1104 may send (e.g., transmit) frame 1114 to STA 1108 associated with AP 1104. AP 1102 may send (e.g., transmit) frame 1112 to STA 1108 associated with slave AP 1104, and AP 1104 may send (e.g., transmit) frame 1114 to STA 1108 associated with AP 1104, for example, if the multi-AP transmission scheme is JT/JR. The resources for sending (e.g., transmitting) and receiving frames 1112 and 1114 may depend on the specific multi-AP transmission scheme adopted.

STAs 1106 and 1108 may acknowledge frames 1112 and 1114 respectively. For example, STA 1106 may send (e.g., transmit) a frame 1116 to AP 1102, and STA 1108 may send (e.g., transmit) a frame 1118 to AP 1104. Frames 1116 and 1118 may comprise block ack (BA) frames. STAs 1106 and 1108 may send (e.g., transmit) frames 1116 and 1118 to APs in different BSSs. STAs 1106 and 1108 may send (e.g., transmit) frames 1116 and 1118 to APs in different BSSs, for example, if required by the used multi-AP transmission scheme. STA 1106 may send (e.g., transmit) frame 1116 to AP 1104, and STA 1108 may send (e.g., transmit) frame 1118 to AP 1102. STA 1106 may send (e.g., transmit) frame 1116 to AP 1104, and STA 1108 may send (e.g., transmit) frame 1118 to AP 1102, for example, if the multi-AP transmission scheme is JT/JR. The resources for sending (e.g., transmitting) and receiving frames 1116 and 1118 may depend on the specific multi-AP transmission scheme adopted.

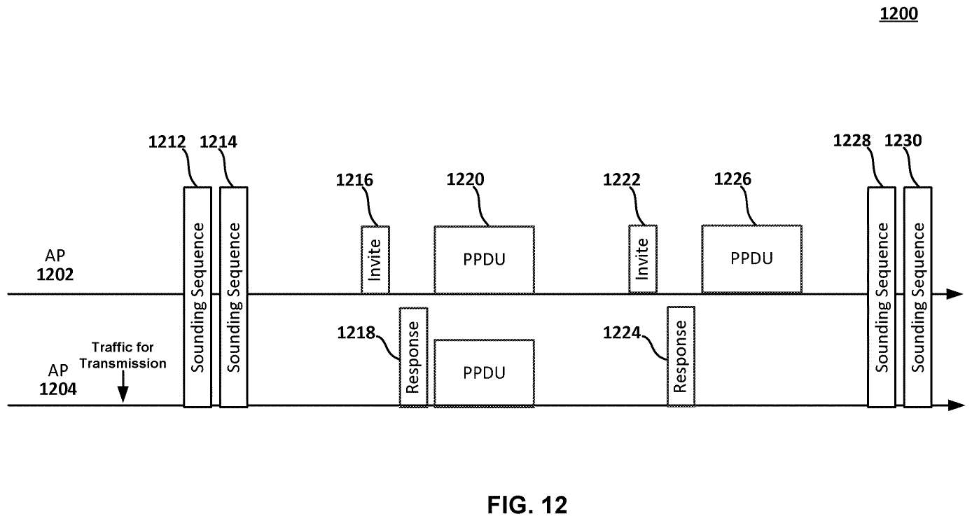

FIG. 12 shows an example NDP sounding procedures. As shown in FIG. 12, example 1200 may include AP 1202 and AP 1204. AP 1202 and AP 1204 may form a multi-AP group. AP 1202 may perform a coordinated beamforming (CoBF) procedure with AP 1204 during (or in) a TXOP obtained by the AP 1202. AP 1202 may be the AP coordinating/controlling the CoBF procedure. AP 1202 may be referred to as a master/sharing AP. AP 1204 may be referred to as a slave/shared AP.

As shown in FIG. 12, AP 1204 may begin with traffic for transmission. For example, the traffic may be for transmission using CoBF (e.g., using a CoBF PPDU). A CoBF PPDU may be any PPDU format that may be used by a sharing AP (e.g., AP 1202) and/or a shared AP (e.g., AP 1204) to beamform their respective data streams, for example, during a CoBF transmission. A CoBF PPDU may include a UHR multi-user (MU) PPDU with an indication of CoBF transmission in the U-SIG field. AP 1204 may have one or more buffered bufferable units (BUs) available for transmission using a CoBF PPDU. A buffered BU available for transmission using a CoBF PPDU may include any buffered BU for any STA that may be capable of responding as a beamformee during an NDP sounding procedure for CoBF transmission.

AP 1202 and AP 1204 may perform a sounding sequence 1212 and/or a sounding sequence 1214 (e.g., as part of a sounding procedure for coordinated beamforming). AP 1202 may be a member of a first BSS (e.g., along with a first one or more associated STAs), and AP 1204 may be a member of a second, different, BSS (e.g., along with a second one or more associated STAs). For example, the first BSS, of which AP 1202 may be a member, may be an overlapping basic service set (OBSS) with the second BSS of which AP 1204 is a member. Sounding sequence 1212 and/or sounding sequence 1214 may be used by AP 1202 and/or AP 1204 to sound STAs in the respect (or separate) BSSs for CoBF. Sounding sequence 1212 may be used by AP 1202 and/or AP 1204 to sound the first BSS including AP 1202 (e.g., to sound channels between the first one or more STAs associated with the first BSS, and each of AP 1202 and AP 1204). Sounding sequence 1214 may be used by AP 1202 and/or AP 1204 to sound the second BSS including AP 1204 (e.g., to sound channels between the second one or more STAs associated with the second BSS, and each of AP 1202 and AP 1204).

Sounding sequence 1212 and/or sounding sequence 1214 may correspond with sounding sequences in a sequential sounding procedure, as described with respect to FIG. 9. AP 1202 may correspond with AP 902 described in FIG. 9. AP 1204 may correspond with AP 904 described in FIG. 9. During sounding sequence 1212, AP 1202 and/or AP 1204 may perform channel sounding phase 910 of FIG. 9 and/or channel sounding phase 920 of FIG. 9, to sound channels between each respective AP and the first one or more STAs in the first BSS associated with AP 1202 (e.g., STA 906 in example 900). During sounding sequence 1214, AP 1202 and/or AP 1204 may perform channel sounding phase 910 of FIG. 9 and/or channel sounding phase 920 of FIG. 9 to sound channels between each respective AP and the second one or more STAs in the second BSS associated with AP 1204 (e.g., STA 908 of FIG. 9).

Sounding sequence 1212 and/or sounding sequence 1214 may correspond with sounding sequences in a joint sounding procedure, as described with respect to FIG. 10. AP 1202 may correspond with AP 1002 of FIG. 10. AP 1204 may correspond with AP 1004 of FIG. 10. Sounding sequence 1212 may correspond with channel sounding phase 1010 of FIG. 10. Both AP 1202 and AP 1204 may sound channels between the respective APs and the first one or more STAs in the first BSS associated with AP 1202 (e.g., STA 1006 of FIG. 10). Sounding sequence 1214 may correspond with channel sounding phase 1020 of FIG. 10. Both AP 1202 and AP 1204 may sound channels between the respective APs and one or more STAs in the second BSS associated with AP 1204 (e.g., STA 1008 in example 1000).

AP 1202 and/or AP 1204 may perform sounding sequence 1212 and/or sounding sequence 1214 to sound channels for two BSSs, for example, to facilitate CoBF by AP 1202 and/or AP 1204. AP 1202 may send (e.g., transmit) an invite 1216 (e.g., a poll) to AP 1204 inviting AP 1204 to join a CoBF transmission. AP 1204 may respond with a response 1218. AP 1204 may indicate, in response 1218, that AP 1204 has data to send via CoBF. AP 1202 may receive response 1218. AP 1202 and/or AP 1204 may send (e.g., transmit) a PPDU 1220 using CoBF (e.g., to a STA associated with AP 1204).

AP 1202 may send (e.g., transmit) another invite 1222 (e.g., a poll) to AP 1204. AP 1204 may respond with another response 1224. AP 1204 may indicate, in response 1224, that AP 1204 has no data to send via CoBF. AP 1204 may have no buffered BU to send (e.g., transmit) to STAs that may support responding as a beamformee in a CoBF transmission. AP 1204 may prioritize transmission of buffered BUs to STAs that may not support CoBF (e.g., for a subsequent duration). AP 1202 may send (e.g., transmit) a PPDU 1226. AP 1202 may send (e.g., transmit) PPDU 1226 without beamforming or using beamforming from AP 1202 alone (e.g., without using CoBF from AP 1202 and/or AP 1204).

AP 1202 and/or AP 1204 may perform additional sounding sequences (e.g., sounding sequence 1228 and/or sounding sequence 1230). AP 1202 and/or AP 1204 may repeat sounding periodically (e.g., at a defined interval) to facilitate transmission using CoBF. Sounding sequence 1228 and/or sounding sequence 1230 may correspond with sounding sequence 1212 and/or sounding sequence 1214 as described herein. AP 1202 and/or AP 1204 may sound STAs in their respective BSSs.

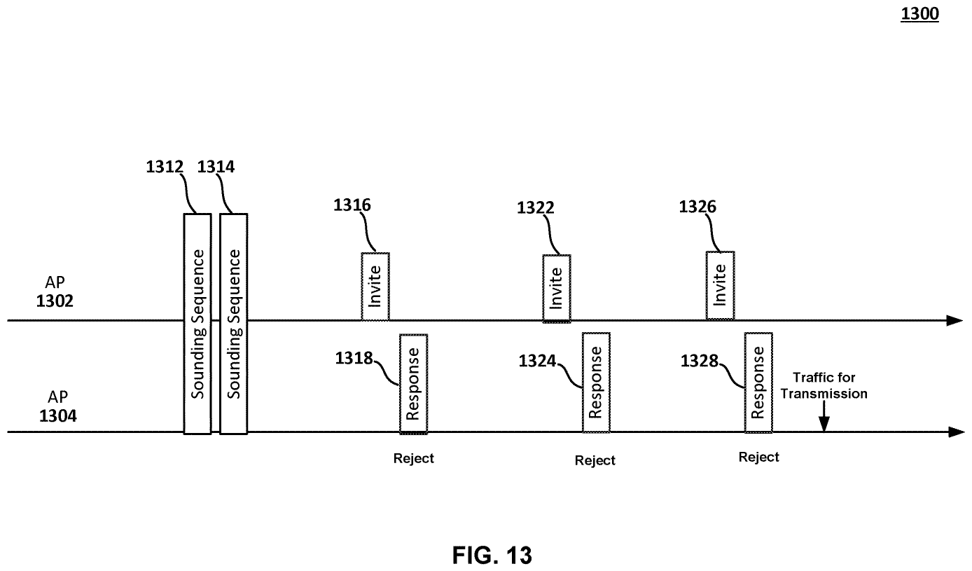

FIG. 13 shows an example problem in multi-AP coordinated transmission. For example, the multi-AP coordinated transmission may comprise coordinated beamforming (CoBF), coordinated spatial reuse (CoSR) transmission, or a coordinated sounding operation. For example, AP 1302 and AP 1304 of FIG. 13 may correspond to AP 1202 and AP 1204 of FIG. 12.

As described with respect to FIG. 13, AP 1302 and AP 1304 may perform (e.g., send or receive) a sounding sequence 1312 and/or a sounding sequence 1314 (e.g., as part of a sounding procedure or coordinated beamforming). Sounding sequence 1312 and sounding sequence 1314 may correspond to sounding sequence 1212 and sounding sequence 1214 of FIG. 12. AP 1302 and/or AP 1304 may perform sounding sequence 1312 and/or sounding sequence 1314 to sound channels for two BSSs, to facilitate CoBF by AP 1302 and/or AP 1304.

As described with respect to FIG. 13, AP 1302 may send (e.g., transmit) an invite 1316 to AP 1304, inviting AP 1304 to join a CoBF transmission. Unlike example 1200, AP 1304 may reject the invite 1316. AP 1304 may not have any data to send via CoBF, for example, after sounding sequence 1312 and/or sounding sequence 1314. AP 1304 may have no buffered BUs to send (e.g., transmit) to STAs that support responding as a beamformee in a CoBF transmission. AP 1304 may prioritize transmission of buffered BUs to STAs that may not support CoBF (e.g., for a subsequent duration). AP 1304 having no data to send via CoBF after sounding sequence 1312 and/or sounding sequence 1314 may be one example of a reason for AP 1304 to reject the invite 1316. As described herein, AP 1304 may reject invite 1316 for any number of suitable reasons (e.g., unavailability of a STA associated with AP 1304 or unavailability of AP 1304, or an error in CSI, among other suitable reasons). AP 1304 may send (e.g., transmit) a response 1318 rejecting the invite 1316.

In at least some wireless communications, an access point such as AP 1302 may send (e.g., transmit) another invite 1322 to another access point such as AP 1304, inviting AP 1304 to join a CoBF transmission. AP 1304 may reject the invitation, for example, by sending (e.g., transmitting) a response 1324 rejecting the invite 1322. For example, AP 1304 may have a prolonged reason for rejecting an invite from AP 1302 to join a CoBF transmission and/or may repeatedly reject any invite. AP 1302 may send (e.g., transmit) an invite 1326 and AP 1304 may reject the invite, sending (e.g., transmitting) a response 1328 rejecting the invite 1326.

This repeated transmission of invites and corresponding rejection responses may result in numerous wasted transmissions. For example, AP 1304 may have a prolonged reason for rejecting any CoBF transmission invite from AP 1302. AP 1302 may continue to send (e.g., transmit) invite 1322 and invite 1326, for example, after the invite 1316 is rejected.

Sending (e.g., transmitting) invite 1322 and/or invite 1326 and response 1324 and/or response 1328, if (or when) not necessary, may be wasteful and/or inefficient, for example, because the resources used by AP 1302 and/or AP 1304 for these transmissions may be wasted. Communication performance (e.g., throughput, resource utilization efficiency, etc.) may be degraded by this unnecessary transmission.

As described herein, communication performance may be improved, for example, by reducing unnecessary transmissions of frames. For example, a first access point (AP) may send (e.g., transmit), to a second AP, a first frame of a first type. The first frame may comprise an invitation to the second AP to join a multi-AP coordinated transmission initiated by the first AP. The first AP may receive, from the second AP, a second frame. The second frame may indicate rejection of the invitation. The second frame may indicate a reason for the rejection. The first AP may send (e.g., transmit), to the second AP, a third frame of the first type, for example, after a first time period. The first time period may be based on the reason.

A first AP may receive, from a second AP, a first frame of a first type. The first frame may comprise an invitation to the first AP to join a multi-AP coordinated transmission initiated by the second AP. The first AP may send (e.g., transmit), to the second AP, a second frame. The second frame may indicate rejection of the invitation. The second frame may indicate a reason for the rejection. The first AP receives, from the second AP, a third frame of the first type, for example, after a first time period. The first time period may be based on the reason.

A first AP may send (e.g., transmit), to a second AP, a first frame of a first type. The first frame may comprise an invitation to the second AP to join a multi-AP coordinated transmission initiated by the first AP. The first AP receives, from the second AP, a second frame. The second frame may indicate rejection of the invitation. The second frame may indicate a first time period. The first AP may send (e.g., transmit), to the second AP, a second frame of the first type, for example, after the first time period.

A first AP may receive, from a second AP, a first frame of a first type. The first frame may comprise an invitation to the first AP to join a multi-AP coordinated transmission initiated by the second AP. The first AP may send (e.g., transmit), to the second AP, a second frame. The second frame may indicate rejection of the invitation. The second frame may indicate a first time period. The first AP may receive, from the second AP, a second frame of the first type, for example, after the first time period. By coordinating frame (e.g., invitation frame and/or rejection frame) transmissions, APs may reduce unnecessary transmission of invitation frames and/or rejection frames for multi-AP coordinated transmission, thereby increasing a likelihood of improved communication efficiency.

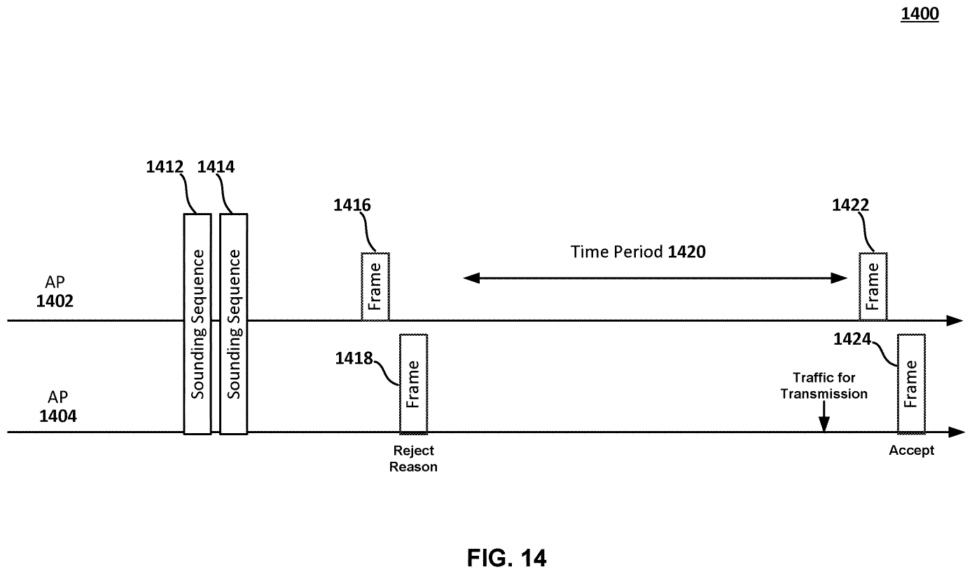

FIG. 14 shows an example method for a multi-AP coordinated transmission. As described with respect to FIG. 14, AP 1402 and AP 1404 may form a multi-AP group. AP 1402 may perform a multi-AP coordinated transmission (e.g., a CoBF transmission, a CoSR transmission, or a coordinated sounding operation) with AP 1404 in a TXOP obtained by AP 1402 (and/or in a TXOP obtained by AP 1404). AP 1402 may be the AP coordinating/controlling the multi-AP coordinated transmission procedure. AP 1402 may be referred to as a master/sharing AP. AP 1404 may be referred to as a slave/shared AP.

As described with respect to FIG. 14, AP 1402 and AP 1404 may perform a sounding sequence 1412 and/or a sounding sequence 1414 (e.g., as part of a sounding procedure for multi-AP coordinated transmission). Sounding sequence 1412 may correspond with sounding sequence 1212 of FIG. 12. Sounding sequence 1414 may correspond with sounding sequence 1214 of FIG. 12.

AP 1402 may be a member of a first BSS (e.g., along with one or more STAs associated with the first BSS). AP 1404 may be a member of a second, different, BSS (e.g., along with one or more STAs associated with the second BSS). The first BSS including AP 1402 may overlap with the second BSS including AP 1404, forming an overlapping basic service set (OBSS). Sounding sequence 1412 and/or sounding sequence 1414 may be used by AP 1402 and/or AP 1404 to sound STAs in the separate BSSs for multi-AP coordinated transmission. Sounding sequence 1412 may be used by AP 1402 and/or AP 1404 to sound the first BSS including AP 1402 (e.g., to sound channels between one or more STAs associated with the first BSS and each of AP 1402 and AP 1404). Sounding sequence 1414 may be used by AP 1402 and/or AP 1404 to sound a second BSS including AP 1404 (e.g., to sound channels between one or more STAs associated with the second BSS and each of AP 1402 and AP 1404).

Sounding sequence 1412 and/or sounding sequence 1414 may correspond with sounding sequences in a sequential sounding procedure as described with respect to FIG. 9. AP 1402 may correspond with AP 902 of FIG. 9. AP 1404 may correspond with AP 904 of FIG. 9. AP 1402 and/or AP 1404 may perform channel sounding phase (e.g., channel sounding phase 910 of FIG. 9) and/or channel sounding phase (e.g., channel sounding phase 920 of FIG. 9) to sound channels between each AP and one or more STAs associated with the first BSS including AP 1402 (e.g., STA 906 of FIG. 9, for example, during sounding sequence 1412. AP 1402 and/or AP 1404 may perform channel sounding phase (e.g., channel sounding phase 910 of FIG. 9) and/or channel sounding phase (e.g., channel sounding phase 920 of FIG. 9) to sound channels between each AP and one or more STAs associated with the second BSS including AP 1404 (e.g., STA 908 of FIG. 9), for example, during sounding sequence 1414.

Sounding sequences 1412 and/or sounding sequence 1414 may correspond with sounding sequences in a joint sounding procedure as described with respect to FIG. 10. AP 1402 may correspond with AP 1002 of FIG. 10. AP 1404 may correspond with AP 1004 of FIG. 10. Sounding sequence 1412 may correspond with channel sounding phase 1010 of FIG. 10. AP 1402 and/or AP 1404 may sound channels between the APs and one or more STAs associated with the first BSS including AP 1402 (e.g., STA 1006 of FIG. 10). Sounding sequence 1414 may correspond with channel sounding phase 1020 of FIG. 10. AP 1402 and/or AP 1404 may sound channels between the APs and one or more STAs associated with the second BSS including AP 1404 (e.g., STA 1008 of FIG. 10). AP 1402 and/or AP 1404 may perform sounding sequence 1412 and/or sounding sequence 1414 to sound channels for two BSSs, for example, to facilitate multi-AP coordinated transmission by AP 1402 and AP 1404.

AP 1402 may send (e.g., transmit), to AP 1404, a frame 1416. The frame 1416 may comprise an invite frame (e.g., a CoBF request frame, a CoSR request frame, or a coordinated sounding request frame) inviting (or requesting) AP 1404 to join a multi-AP coordinated transmission (e.g., a CoBF transmission, a CoSR transmission, or a coordinated sounding operation). The frame 1416 may comprise a trigger frame. For example, frame 1416 may have a format corresponding to trigger frame 600 as shown in FIG. 6. The frame 1416 may comprise an initial control frame (ICF) that may initiate a transmit opportunity (TXOP) during which the multi-AP coordinate transmission may occur.

AP 1404 may receive frame 1416. AP 1404 may respond by sending (e.g., transmitting) a frame 1418 to AP 1402. The frame 1418 may comprise a response frame (e.g., a CoBF response frame, a CoSR response frame, or a coordinated sounding response frame), responding to the frame 1416 (e.g., responding to an invite/request frame, inviting/requesting AP 1404 to join a multi-AP coordinated transmission with AP 1402). The frame 1418 may indicate that AP 1404 rejects the invite/request included in the frame 1416.

The frame 1418 may indicate a reason for the rejection. For example, AP 1404 may expect to reject any invite/request frame for a period of time. AP 1404 may indicate, in the frame 1418, a reason for the rejection.

The frame 1418 may indicate that AP 1404 may not have any data to send via multi-AP coordinated transmission. AP 1404 may have no buffered BUs to send (e.g., transmit) to STAs that support responding to a coordinated transmission (e.g., responding as a beamformee in a CoBF transmission). AP 1404 may prioritize transmission of buffered BUs to STAs that may not support multi-AP coordinated transmission (e.g., for a subsequent duration).

The frame 1418 may indicate that AP 1404 is unavailable. AP 1404 may be unavailable (or expect to be unavailable) during a multi-AP coordinated transmission (e.g., a Co-BF transmission or a CoSR transmission). AP 1404 may be unavailable (or expect to be unavailable) during a multi-AP coordinated transmission (e.g., a Co-BF transmission or a CoSR transmission), for example, due to a coexistence event, a power saving mode (e.g., AP 1404 expecting to enter a power save mode in which it may not participate in a multi-AP coordinated transmission), or any other reason. Frame 1418 may indicate the unavailability of AP 1404. The frame 1418 may indicate additional information about the unavailability of AP 1404 (e.g., a coexistence event, a power saving mode, or any other suitable information).

The frame 1418 may indicate that a STA (e.g., a destination STA for a multi-AP transmission) is unavailable. AP 1404 may identify a STA (e.g., associated with AP 1404 or AP 1402) that may act as a destination for a multi-AP coordinated transmission, as unavailable. The STA may be unavailable, for example, during a multi-AP coordinated transmission. The STA may be unavailable, for example, due to a coexistence event, a power saving mode for the STA, or any other reason. The frame 1418 may indicate the unavailability of a STA. The frame 1418 may indicate the particular STA that is unavailable or expected to be unavailable (e.g., using a suitable identifier). The frame 1418 may indicate additional information about the unavailability of the STA (e.g., a coexistence event, a power saving mode, or any other information).

The frame 1418 may indicate a sounding error (e.g., during sounding sequence 1412 and/or sounding sequence 1414). The frame 1418 may indicate an error in CSI (e.g., relating to a channel between a STA and AP 1404). AP 1404 may identify that incomplete or expired CSI is available for a channel between AP 1404 and a destination STA (e.g., a STA associated with either AP 1402 or AP 1404 that may serve as a destination for a multi-AP coordinated transmission). The frame 1418 may indicate the error in CSI. The frame 1418 may indicate a particular STA associated with the CSI error (e.g., a particular STA for which there is an error in CSI for a channel between that STA and AP 1404).

The frame 1418 may indicate additional information about the error in CSI (e.g., whether the CSI is incomplete or expired). The frame 1418 may indicate that the error in CSI includes a failure to update CSI feedback (e.g., for a STA) within a time interval. For example, the time interval may relate to a sounding interval. The sounding interval may be, for example, between 10 ms (or any other value) and 100 ms (or any other value). Frame 1418 may indicate that the error in CSI includes a failure to update CSI feedback (e.g., for a STA) within the sounding interval (e.g., within a time period between 10 ms (or any other value) and 100 ms (or any other value)).

The frame 1418 may indicate that QoS characteristics lead to AP 1404 rejecting the invitation for the multi-AP coordinated transmission. The frame 1418 may indicate an unspecified reason for the rejection. The frame 1418 may include a code (e.g., a pre-determined code value) indicating that the reason for rejection is unspecified.

As described herein, AP 1404 may indicate, in the frame 1418, a reason for rejecting the invite/request, from AP 1402, to participate in the multi-AP coordinated transmission. For example, the frame 1418 may comprise a BA frame. The frame 1418 may have a format correspond to example BA frame 700 as shown in FIG. 7. The frame 1418 may include a code indicating the reason for rejection (e.g., a pre-determined code value corresponding to a reason for rejection), a textual indication of the reason for rejection, or any other indication. The frame 1418 may comprise an initial response, for example, if (or when) the frame 1416 comprises an initial control frame. The frame 1418 may comprise a QoS null frame.

AP 1402 may receive the frame 1418. AP 1402 may identify the indication, in the frame 1418, of the reason AP 1404 rejected the invite/request (e.g., the reason AP 1404 rejected the invite/request, in the frame 1416, to join a multi-AP coordinated transmission). AP 1402 may use the indication to determine a time period 1420 (e.g., a duration), to wait before sending (e.g, transmitting) another invite/request. The time period 1420 (e.g., the length of time period 1420) may be based on the reason for rejection indicated in the frame 1418.

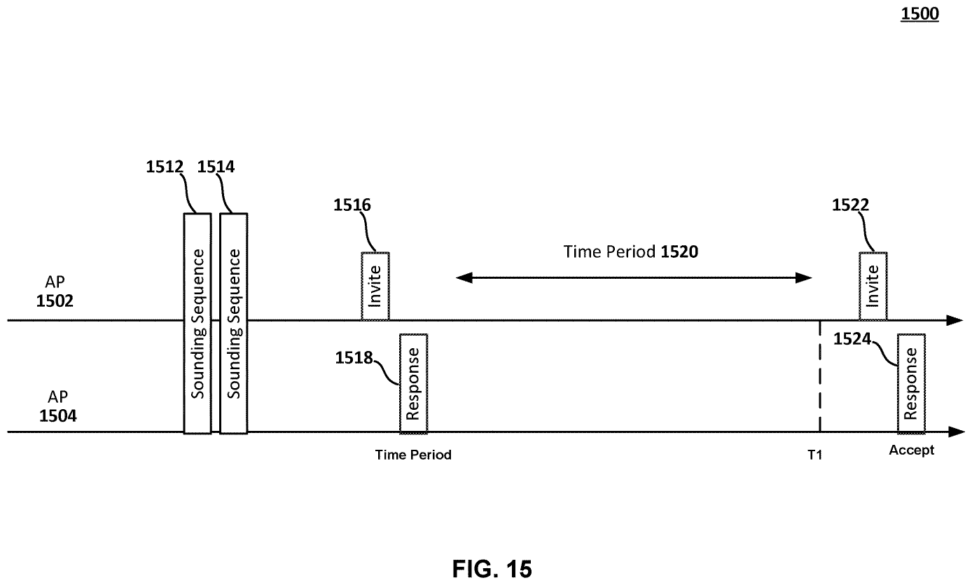

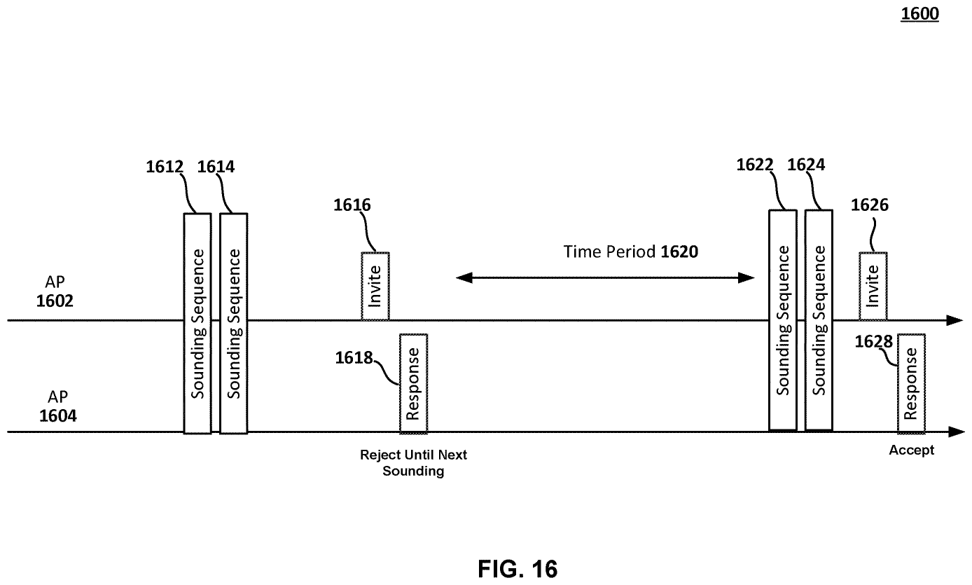

As described herein with respect to FIG. 15 and/or FIG. 16, the frame 1418 may indicate a time period, for example, in addition to or instead of indicating a reason for rejection. For example, the frame 1418 may indicate a time period for a reason for rejection, in addition to the reason for rejection. The frame 1418 may indicate a time period for unavailability of AP 1404 for multi-AP coordinated transmission. The frame 1418 may indicate a time period for unavailability of a STA for multi-AP coordinated transmission (e.g., a STA associated with AP 1404 or a STA associated with AP 1402). The frame 1418 may indicate a time period relating to any reason for rejection. AP 1402 may use the time period indicated in the frame 1418 to determine the time period 1420 to wait before sending (e.g., transmitting) another invite/request. For example, the time period 1420 may be equal to a time period indicated in the frame 1418. The time period 1420 may be determined (e.g., by AP 1404), for example, based on a reason for rejection included in the frame 1418 and/or a time period included in the frame 1418.

The frame 1418 may indicate the time period by indicating a start time and/or a duration. For example, AP 1404 (or a STA associated with AP 1404) may support a dynamic unavailability operation (DUO) mode. A DUO mode may allow a STA (e.g., an AP STA or a non-AP STA) to indicate unavailability in certain control frames. A non-AP STA operating in a DUO mode may indicate (e.g., in a response multi-STA BA frame) whether the non-AP STA may be unavailable after a specific point in time and/or, if known, how long the non-AP STA may be unavailable. This indication may be provided using a DUO feedback subfield that may include an unavailability target start time subfield (e.g., a nine-bit field) and/or an unavailability duration subfield (e.g., a nine-bit field). The frame 1418 may include a DUO feedback subfield. The frame 1418 may include the start time and/or duration in the DUO feedback subfield. For example, the frame 1418 may include the start time in an unavailability target start time subfield. The frame 1418 may include the duration in an unavailability duration subfield. As described herein, the start time and/or duration may relate to unavailability of AP 1404 for a multi-AP coordinated transmission, unavailability of a STA for multi-AP coordinated transmission, or any other reason for rejection of an invitation for multi-AP coordinated transmission.

The frame 1418 may indicate an end time. For example, the frame 1418 may indicate an end time after which AP 1404 may accept an invite/request frame inviting/requesting AP 1404 to join a multi-AP coordinated transmission with AP 1402.

AP 1402 may send (e.g., transmit) a frame 1422 after the time period 1420. The frame 1422 may comprise an invite/request frame inviting/requesting AP 1404 to join a multi-AP coordinated transmission. For example, frame 1422 may comprise a same type as the frame 1416. The frame 1422 may comprise a retransmission of frame 1416. The frame 1422 may comprise a trigger frame. For example, the frame 1416 may have a format corresponding to trigger frame 600 as shown in FIG. 6.

AP 1404 may receive the frame 1422. AP 1404 may respond to the frame 1422 by sending (e.g., transmitting) the frame 1424. The frame 1424 may comprise a response frame. For example, AP 1404 may indicate, in the frame 1424, that AP 1404 may accept the invite/request to join a multi-AP coordinated transmission indicated in the frame 1422. For example, AP 1404 may have received data (e.g., buffered BUs) to send via a multi-AP coordinated transmission to a destination STA. The reason for the rejection indicated in the frame 1418 by AP 1404 may have subsided. For example, an unavailability issue (e.g., for AP 1404 or a STA) may have subsided. A sounding failure (e.g., a CSI error) may have subsided or been cured (e.g., based on additional sounding). QoS characteristics may support the multi-AP coordinated transmission (e.g., QoS requirements or characteristics may have changed).

AP 1404 and/or AP 1402 may undertake a multi-AP coordinated transmission (e.g., a CoBF transmission, a CoSR transmission, or a coordinated sounding operation), for example, after AP 1404 sends (e.g., transmits) the frame 1424. For example, AP 1402 and AP 1404 may avoid unnecessary (or wasted) invite/request frames and/or response frames for multi-AP coordinated transmission (e.g., during time period 1420). By avoiding unnecessary invite/request frame and/or response frame, communication efficiency may be improved.

The frame 1418 may include a field indicating whether AP 1404 intends/wishes to perform CoBF transmission or CoSR transmission with AP 1402, even if AP 1404 may reject, via the frame 1418, the request for coordinated sounding contained in the coordinated sounding request frame, for example, if the frame 1416 comprises a coordinated sounding request frame.

The frame 1418 may indicate that AP 1404 uses CSI obtained from a previous coordinated sounding operation (e.g. sounding sequence 1412 and/or sounding sequence 1414) or that AP 1404 prefers to use CoSR transmission instead of CoBF transmission, for example, if AP 1404 indicates in the frame 1418 that AP 1404 intends/wishes to perform CoBF transmission or CoSR transmission.

The field indicating whether AP 1404 intends/wishes to perform CoBF transmission or CoSR transmission with AP 1402 may be provided as a substitute for, or in addition to, the reason for rejection in the frame 1418. AP 1404 may indicate its intention/wish to perform CoBF transmission or CoSR transmission in the frame 1418, for example, if (or when) AP 1404 has buffered traffic for its associated CoBF/CoSR candidate STAs but an interval for coordinated sounding operation of AP 1402 may not match an interval for coordinated sounding operation of AP 1404 (e.g., the interval between sounding sequence 1412 (or sounding sequence 1414) and the frame 1416 may be too short for AP 1404). AP 1402 may use a subsequent TXOP to perform a non-CoBF transmission, for example, after receiving the frame 1418 indicating rejection of the coordinated sounding request in the frame 1416 and/or indicating that AP 1404 may not intend/wish to perform CoBF transmission or CoSR transmission with AP 1402.

AP 1402 may use a subsequent TXOP to perform a CoBF/CoSR transmission with AP 1404, for example, after receiving the frame 1418 indicating rejection of the coordinated sounding request in the frame 1416 and/or indicating that AP 1404 intends/wishes to perform CoBF transmission or CoSR transmission with AP 1402. AP 1402 may send (e.g., transmit) the frame 1422 to invite AP 1404 to perform CoBF/CoSR transmission, for example, based on earlier performance of a successful coordinated sounding sequence with AP 1404 (e.g., sounding sequence 1412 and/or 1414). AP 1402 may use a subsequent TXOP to perform a CoBF/CoSR transmission with AP 1404, for example, after receiving the frame 1418 indicating rejection of the coordinated sounding request and/or without the field indicating whether AP 1404 intends/wishes to perform CoBF transmission or CoSR transmission with AP 1402. AP 1402 may use a shorter time period 1420 to wait before sending (e.g., transmitting) the frame 1422 (e.g., assuming the subsequent TXOP is initiated by the frame 1422), for example, if AP 1402 uses a subsequent TXOP to perform a CoBF/CoSR transmission with AP 1404 after AP 1404 rejects a coordinated sounding request. AP 1402 may use a more robust modulation and coding scheme (MCS) in a following CoBF PPDU transmission than AP 1402 may have used if the coordinated sounding operation had not been rejected by AP 1404.

FIG. 15 shows an example method for a multi-AP coordinated transmission. AP 1502 may correspond to AP 1402 of FIG. 14, and/or AP 1504 may correspond to AP 1404 of FIG. 14

As described with respect to FIG. 15, AP 1502 and AP 1504 may perform a sounding sequence 1512 and/or a sounding sequence 1514 (e.g., as part of a sounding procedure for multi-AP coordinated transmission, such as a CoBF transmission, a CoSR transmission, or a coordinated sounding operation). Sounding sequence 1512 corresponds to sounding sequence 1412 of FIG. 14. Sounding sequence 1514 may correspond to sounding sequence 1414 of FIG. 14. AP 1502 and/or AP 1504 may perform sounding sequence 1512 and/or sounding sequence 1514 to sound channels for two BSSs, for example, to facilitate multi-AP coordinated transmission by AP 1502 and/or AP 1504.

AP 1502 may send (e.g., transmit), to AP 1504, a frame 1516. The frame 1516 may comprise an invite frame (e.g., a CoBF request frame, a CoSR request frame, or a coordinated sounding request frame), inviting (or requesting) AP 1504 to join a multi-AP coordinated transmission (e.g., a CoBF transmission, a CoSR transmission, or a coordinated sounding transmission). The frame 1516 may comprise a trigger frame. For example, the frame 1516 may have a format corresponding to trigger frame 600 as shown in FIG. 6.

AP 1504 may receive the frame 1516. AP 1504 may respond by sending (e.g., transmitting) a frame 1518 to AP 1502. The frame 1518 may comprise a response frame (e.g., a CoBF response frame, CoSR response frame, or a coordinated sounding response frame), responding to the frame 1516 (e.g., responding to an invite/request frame, inviting/requesting AP 1504 to join a multi-AP coordinated transmission with AP 1502). The frame 1518 may indicate that AP 1504 rejects the invite/request included in the frame 1516.

The frame 1518 may indicate a time period relating to unavailability for a multi-AP coordinated transmission. For example, AP 1504 may expect to reject any invite/request frame for a time period. The frame 1518 may indicate this time period.

The frame 1518 may indicate a time period 1520 relating to unavailability for a multi-AP coordinated transmission. The frame 1518 may indicate the time period 1520 by indicating a start time and/or a duration (e.g., for the time period 1520). For example, AP 1504 (or a STA associated with AP 1504) may support a DUO mode, as described herein with respect to FIG. 14. The frame 1518 may include a DUO feedback subfield. The frame 1518 may include the start time and/or duration in the DUO feedback subfield. For example, the frame 1518 may include the start time in an unavailability target start time subfield. The frame 1518 may include the duration in an unavailability duration subfield.

The frame 1518 may indicate the time period 1520, for example, by indicating an end time. For example, the frame 1518 may indicate an end time T1, after which AP 1504 may accept an invite/request frame that may invite/request AP 1504 to join a multi-AP coordinated transmission with AP 1502.

AP 1502 may receive the frame 1518. AP 1502 may identify the indication, in the frame 1518, of the time period 1520. AP 1502 may use the time period 1520 to determine when (or if) to send (e.g., transmit) another invite/request.

AP 1502 may send (e.g., transmit) a frame 1522 after the time period 1520. The frame 1522 may comprise an invite/request frame inviting/requesting AP 1504 to join a multi-AP coordinated transmission. For example, the frame 1522 may have a same type as the frame 1516. The frame 1522 may be a retransmission of frame 1516. The frame 1522 may comprise a trigger frame. For example, frame 1522 may have a format corresponding to trigger frame 600 as shown in FIG. 6.

AP 1504 may receive the frame 1522. AP 1504 may respond to the frame 1522 by sending (e.g., transmitting) a frame 1524. The frame 1524 may comprise a response frame. For example, AP 1504 may indicate in the frame 1524 that AP 1504 accepts the invite/request to join a multi-AP coordinated transmission, indicated in the frame 1522. AP 1504 may accept the invite/request to join the multi-AP coordinated transmission, for example, after the time period 1520 has passed.

AP 1504 and AP 1502 may undertake a multi-AP coordinated transmission (e.g., a CoBF transmission, a CoSR transmission, or a coordinated sounding operation), for example, after AP 1504 sends (e.g., transmits) the frame 1524. For example, AP 1502 and AP 1504 may avoid unnecessary (or wasted) invite/request frame and/or response frame for multi-AP coordinated transmission (e.g., during time period 1520). By avoiding unnecessary invite/request frame and/or response frame, communication efficiency may be improved.

FIG. 16 shows an example method for a multi-AP coordinated transmission. AP 1602 may correspond to AP 1402 of FIG. 14. AP 1604 may correspond to AP 1404 of FIG. 14.

As described with respect to FIG. 16, AP 1602 and AP 1604 may perform a sounding sequence 1612 and/or a sounding sequence 1614 (e.g., as part of a sounding procedure for multi-AP coordinated transmission, such as a CoBF transmission, a CoSR transmission, or a coordinated sounding operation). Sounding sequence 1612 may correspond to sounding sequence 1412, and/or sounding sequence 1614 may correspond to sounding sequence 1414, as described herein with respect to FIG. 14. AP 1602 and AP 1604 may perform sounding sequence 1612 and/or sounding sequence 1614 to sound channels for two BSSs, for example, to facilitate multi-AP coordinated transmission by AP 1602 and AP 1604.

As described with respect to FIG. 16, AP 1602 may send (e.g., transmit) a frame 1616 to AP 1604. The frame 1616 may comprise an invite frame (e.g., a CoBF request frame, a CoSR request frame, or a coordinated sounding request frame), inviting (or requesting) AP 1604 to join a multi-AP coordinated transmission (e.g., a CoBF transmission, a CoSR transmission, or a coordinated sounding transmission). The frame 1616 may be a trigger frame. For example, the frame 1616 may have a format corresponding to trigger frame 600 as shown in FIG. 6.

AP 1604 may receive the frame 1616 and may respond by sending (e.g., transmitting) a frame 1618 to AP 1602. The frame 1618 may comprise a response frame (e.g., a CoBF response frame, CoSR response frame, or a coordinated sounding response frame), responding to the frame 1616 (e.g., responding to an invite/request frame, inviting/requesting AP 1604 to join a multi-AP coordinated transmission with AP 1602). The frame 1618 may indicate that AP 1604 rejects the invite/request included in the frame 1616.

The frame 1618 may indicate a next event, for example, before accepting an invite/request to join a multi-AP coordinated transmission. AP 1604 may expect to reject any invite/request frame, for example, until a next sounding procedure is completed. As described herein with respect to FIG. 10, FIG. 11, and/or FIG. 12, AP 1602 and AP 1604 may periodically repeat sounding (e.g., at a defined interval) to facilitate multi-AP coordinated transmission. AP 1604 may expect to reject any invite/request frame, for example, until the next intermittent sounding procedure is completed (e.g., due to a CSI error stemming from a prior sounding procedure, as described herein with respect to FIG. 14).

Frame 1618 may indicate that AP 1604 will reject an invite/request, for multi-AP coordinated transmission, for example, until a next sounding procedure completes. For example, frame 1618 may include a code (e.g., a pre-determined code value) indicating the rejection until the next sounding procedure. A sounding procedure may be one example of an event that may be indicated in frame 1618 (e.g., an event before AP 1604 accepts an invite/request to join a multi-AP coordinated transmission). Frame 1618 may indicate any event (e.g., using a pre-determined code value).

AP 1602 may receive frame 1618 and/or determine that time period 1620 may pass, for example, before a next sounding procedure (e.g., based on a defined interval for sounding). AP 1602 may wait to send (e.g., transmit) any invite/request for a multi-AP coordinated transmission, for example, until after time period 1620 and/or the sounding procedure is completed. AP 1602 and AP 1604 may perform a sounding sequence 1622 and/or a sounding sequence 1624, for example, after the time period 1620. Sounding sequences 1622 and 1624 may correspond to sounding sequences 1612 and 1614, respectively, periodically repeated after an interval (e.g., a suitable interval). Sounding sequence 1622 may correspond to sounding sequence 1412, and/or sounding sequence 1624 may correspond to sounding sequence 1414, as described herein with respect to FIG. 14. As described with respect to FIG. 14, AP 1602 and AP 1604 may perform sounding sequence 1622 and/or sounding sequence 1624 to sound channels for two BSSs, for example, to facilitate multi-AP coordinated transmission by AP 1602 and AP 1604.

AP 1602 may send (e.g., transmit) a frame 1626, for example, after sounding sequence 1622 and/or sounding sequence 1624. The frame 1626 may be an invite (or request) frame inviting/requesting AP 1604 to join a multi-AP coordinated transmission. For example, the frame 1626 may have a same type as the frame 1616. The frame 1626 may be a retransmission of the frame 1616. The frame 1626 may be a trigger frame. For example, the frame 1626 may have a format corresponding to trigger frame 600 as shown in FIG. 6.

AP 1604 may receive the frame 1626. AP 1604 may respond to the frame 1626, for example, by sending (e.g., transmitting) a frame 1628. The frame 1628 may comprise a response frame. For example, AP 1604 may indicate, in the frame 1628, that AP 1604 may accept the invite/request to join a multi-AP coordinated transmission, indicated in the frame 1626. AP 1604 may accept the invite/request to join the multi-AP coordinated transmission, for example, after the time period 1620 has passed and AP 1602 and AP 1604 have completed sounding sequence 1622 and/or sounding sequence 1624.

AP 1604 and AP 1602 may undertake a multi-AP coordinated transmission (e.g., a CoBF transmission, a CoSR transmission, or a coordinated sounding operation), for example, after AP 1604 may send (e.g., transmit) frame 1628. For example, AP 1602 and AP 1604 may avoid unnecessary (or wasted) invite/request frame and/or response frame for multi-AP coordinated transmission (e.g., during the time period 1620). By avoiding unnecessary invite/request frame and/or response frame, communication efficiency may be improved.

As would be understood by a person of skill in the art based on the teachings herein, the examples as described herein may be extended to examples including more than one STA. As would be understood by a person of skill in the art based on the teachings herein, the examples as described herein may be extended to examples including more than one AP. As would be understood by a person of skill in the art based on the teachings herein, the examples as described herein may be extended to examples in which any of the APs and/or any of the STAs may comprise a MLD, comprising at least one affiliated AP and/or affiliated STA.

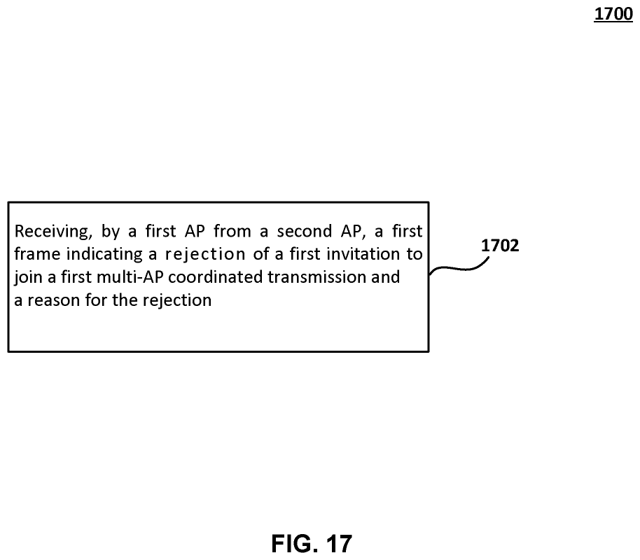

FIG. 17 shows an example method for a multi-AP coordinated transmission. For example, method 1700 may be performed by any AP, for example, such as AP 1402, AP 1502, or AP 1602 as shown in FIG. 14, FIG. 15, and/or FIG. 16. As shown in FIG. 17, method 1700 may include step 1702.

At step 1702, a first AP may receive, from a second AP, a first frame indicating a rejection of a first invitation to join a first multi-AP coordinated transmission and/or a reason for the rejection. The second AP may be any AP, for example, such as AP 1404, AP 1504, and/or AP 1604, as shown in FIG. 14, FIG. 15, and/or FIG. 16.

The reason for the rejection may indicate at least one of: unavailability of a first STA associated with the second AP, unavailability of the second AP, an error in channel state information (CSI) relating to a channel between a second STA and the second AP, absence of buffered units (BUs) at the second AP for a third STA associated with the second AP, or an unspecified reason. The reason for the rejection may comprise unavailability of the first STA associated with the second AP.

The unavailability of the first STA may be during the first multi-AP coordinated transmission. The unavailability of the first STA may relate to a power save mode or a coexistence event for the first STA. The reason for the rejection may comprise unavailability of the second AP.

The first frame may comprise an unavailability period feedback field comprising a first start time and/or a first duration. The first start time may indicate a time at which the second AP becomes unavailable for the first multi-AP coordinated transmission. The first duration may indicate a duration after the first start time during which the second AP remains unavailable for the first multi-AP coordinated transmission.

The first start time may indicate a time at which the first STA becomes unavailable for the first multi-AP coordinated transmission. The first duration may indicate a duration after the first start time during which the first STA remains unavailable for the first multi-AP coordinated transmission.

The reason for the rejection may comprise the error in CSI relating to the channel between the second STA and the second AP. The error in CSI relating to the second STA may comprise an error in receiving CSI feedback from the second STA. The error in CSI relating to the second STA may comprise a failure to update CSI feedback relating to the second STA within a time interval. For example, the time interval may be greater than 10 ms and less than 100 ms.

The second STA may be associated with the first AP. The second STA may be associated with the second AP.

The reason for the rejection may comprise the absence of buffered BUs at the second AP for the third STA. The reason for the rejection may comprise the unspecified reason. The first frame may indicate the unspecified reason using a pre-determined code value.

The first AP may send (e.g., transmit), to the second AP, a second frame comprising the first invitation. The first AP may receive, from the second AP, the first frame, for example, based on (e.g., in response to) sending (e.g., transmitting) the second frame. For example, the second frame may comprise a coordinated beamforming (CoBF) request frame.

The first AP may send (e.g., transmit), to the second AP, a third frame comprising a second invitation to join a second multi-AP coordination transmission, for example, after a first time period. The second invitation may comprise a retransmission of the first invitation. The third frame may comprise a coordinated beamforming (CoBF) request frame. The first time period may be based on the reason.

The first frame may comprise an unavailability period feedback field indicating a start time and/or a duration. The first time period may be based on the start time and the duration. The first frame may indicate a second time period. The first time period may be based on the second time period. The second time period may be equal to the first time period. The first frame may indicate that the first time period is based on a start of a sounding procedure for the first multi-AP coordinated transmission.

The first AP may send (e.g., transmit), to the second AP, a fourth frame initiating a sounding sequence for the first multi-AP coordinated transmission. For example, the first fame may comprise a coordinated beamforming (CoBF) response frame.

The first multi-AP coordinated transmission may comprise coordinated beamforming (CoBF) or coordinated spatial reuse (CoSR). The first multi-AP coordinated transmission may comprise a coordinated sounding operation.

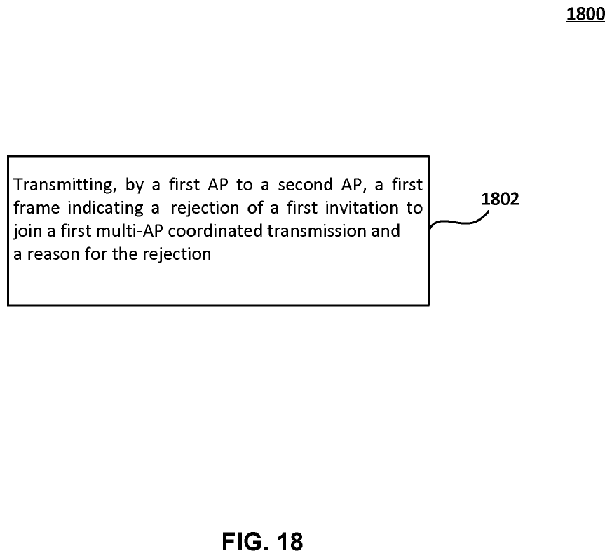

FIG. 18 shows an example method for a multi-AP coordinated transmission. For example, method 1800 may be performed by any AP, for example, such as AP 1404, AP 1504, or AP 1604 as shown in FIG. 14, FIG. 15, and/or FIG. 16. As shown in FIG. 18, method 1800 may include step 1802.

At step 1802, a first AP may send (e.g., transmit), to a second AP, a first frame indicating a rejection of a first invitation to join a first multi-AP coordinated transmission and/or a reason for the rejection. The second AP may be any AP, for example, such as AP 1402, AP 1502, and/or AP 1602, as shown in FIG. 14, FIG. 15, and/or FIG. 16.

The reason for the rejection may indicate at least one of: unavailability of a first STA associated with the first AP, unavailability of the first AP, an error in channel state information (CSI) relating to a channel between a second STA and the first AP, absence of buffered units (BUs) at the first AP for a third STA associated with the first AP, or an unspecified reason. The reason for the rejection may comprise unavailability of the first STA associated with the first AP.

The unavailability of the first STA may be during the first multi-AP coordinated transmission. The unavailability of the first STA may relate to a power save mode or a coexistence event for the first STA. The reason for the rejection may comprise unavailability of the first AP.

The first frame may comprise an unavailability period feedback field comprising a first start time and/or a first duration. The first start time may indicate a time at which the first AP becomes unavailable for the first multi-AP coordinated transmission. The first duration may indicate a duration after the first start time during which the first AP remains unavailable for the first multi-AP coordinated transmission.

The first start time may indicate a time at which the first STA becomes unavailable for the first multi-AP coordinated transmission. The first duration may indicate a duration after the first start time during which the first STA remains unavailable for the first multi-AP coordinated transmission.

The reason for the rejection may comprise the error in CSI relating to the channel between the second STA and the first AP. The error in CSI relating to the second STA may comprise an error in receiving CSI feedback from the second STA. The error in CSI relating to the second STA may comprise a failure to update CSI feedback relating to the second STA within a time interval. For example, the time interval may be greater than 10 ms and less than 100 ms.

The second STA may be associated with the first AP. The second STA may be associated with the second AP.

The reason for the rejection may comprise the absence of buffered BUs at the first AP for the third STA. The reason for the rejection may comprise the unspecified reason. The first frame may indicate the unspecified reason using a pre-determined code value.

The first AP may receive, from the second AP, a second frame comprising the first invitation. The first AP may send (e.g., transmit), to the second AP, the first frame, for example, based on (e.g., in response to) receiving the second frame. For example, the second frame may comprise a coordinated beamforming (CoBF) request frame.

The first AP may receive, from the second AP, a third frame comprising a second invitation to join a second multi-AP coordination transmission, for example, after a first time period. The second invitation may comprise a retransmission of the first invitation. The third frame comprises a coordinated beamforming (CoBF) request frame. The first time period may be based on the reason.

The first frame may comprise an unavailability period feedback field indicating a start time and/or a duration. The first time period may based on the start time and the duration.

The first frame may indicate a second time period. The first time period may be based on the second time period. The second time period may be equal to the first time period. The first frame may indicate that the first time period is based on a start of a sounding procedure for the first multi-AP coordinated transmission.

The first AP may receive, from the second AP, a fourth frame initiating a sounding sequence for the first multi-AP coordinated transmission. The first fame may comprise a coordinated beamforming (CoBF) response frame.

The first multi-AP coordinated transmission may comprise a coordinated beamforming (CoBF) or a coordinated spatial reuse (CoSR). The first multi-AP coordinated transmission may comprise a coordinated sounding operation.

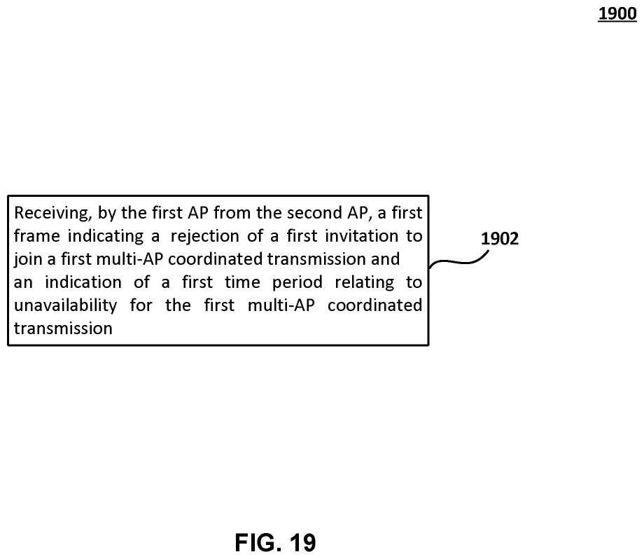

FIG. 19 shows an example method for a multi-AP coordinated transmission. For example, method 1900 may be performed by any AP, for example, such as AP 1402, AP 1502, and/or AP 1602 as shown in FIG. 14, FIG. 15, and/or FIG. 16. As shown in FIG. 19, method 1900 may include step 1902.

At step 1902, a first AP may receive, from the second AP, a first frame indicating a rejection of a first invitation to join a first multi-AP coordinated transmission and/or an indication of a first time period relating to unavailability for the first multi-AP coordinated transmission. The second AP may be any AP, such as AP 1404, AP 1504, and/or AP 1604, as shown in FIG. 14, FIG. 15, and/or FIG. 16.

The first AP may send (e.g., transmit), to the second AP, a second frame comprising the first invitation. The first AP may receive, from the second AP, the first frame, for example, based on (e.g., in response to) sending (e.g., transmitting) the second frame.

The first AP may send (e.g., transmit), to the second AP, a third frame comprising a second invitation to join a second multi-AP coordination transmission, for example, after the first time period. The indication of the first time period may comprise the first time period. The indication of the first time period comprises an indication that the first time period is based on a start of a sounding procedure for the first multi-AP coordinated transmission.

The first AP may send (e.g., transmit), to the second AP, a fourth frame initiating the sounding procedure for the first multi-AP coordinated transmission, for example, after the first time period. The first multi-AP coordinated transmission may comprise a coordinated beamforming (CoBF), a coordinated spatial reuse (CoSR), and/or a coordinated sounding operation.

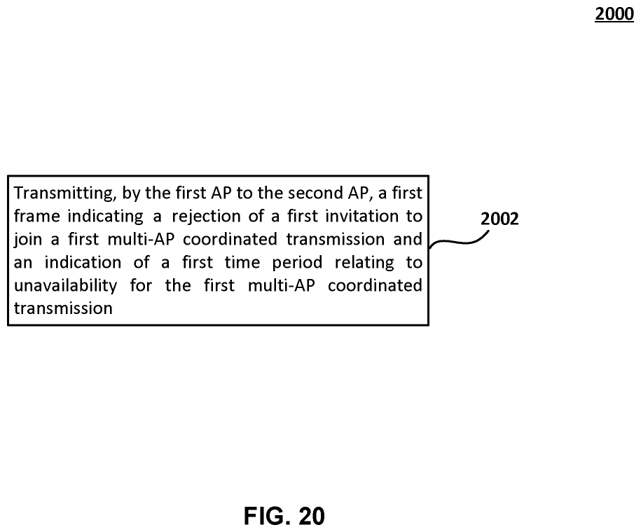

FIG. 20 shows an example method for a multi-AP coordinated transmission. For example, method 2000 may be performed by any AP, for example, such as AP 1404, AP 1504, and/or AP 1604 as shown in FIG. 14, FIG. 15, and/or FIG. 16. As shown in FIG. 20, method 2000 may include step 2002.

At step 2002, a first AP may send (e.g., transmit), to the second AP, a first frame indicating a rejection of a first invitation to join a first multi-AP coordinated transmission and/or an indication of a first time period relating to unavailability for the first multi-AP coordinated transmission. The second AP may be any AP, for example, such as AP 1402, AP 1502, and/or AP 1602 as shown in FIG. 14, FIG. 15, and/or FIG. 16.

The first AP may receive, from the second AP, a second frame comprising the first invitation. The first AP may send (e.g., transmit) the first frame, to the second AP, for example, based on (e.g., in response to) receiving the second frame.

The first AP may receive, from the second AP, a third frame comprising a second invitation to join a second multi-AP coordination transmission, for example, after the first time period. The indication of the first time period may comprise the first time period. The indication of the first time period may comprise an indication that the first time period is based on a start of a sounding procedure for the first multi-AP coordinated transmission.

The first AP may receive, from the second AP, a fourth frame initiating the sounding procedure for the first multi-AP coordinated transmission, for example, after the first time period. The first multi-AP coordinated transmission may comprise a coordinated beamforming (CoBF), a coordinated spatial reuse (CoSR), and/or a coordinated sounding operation.

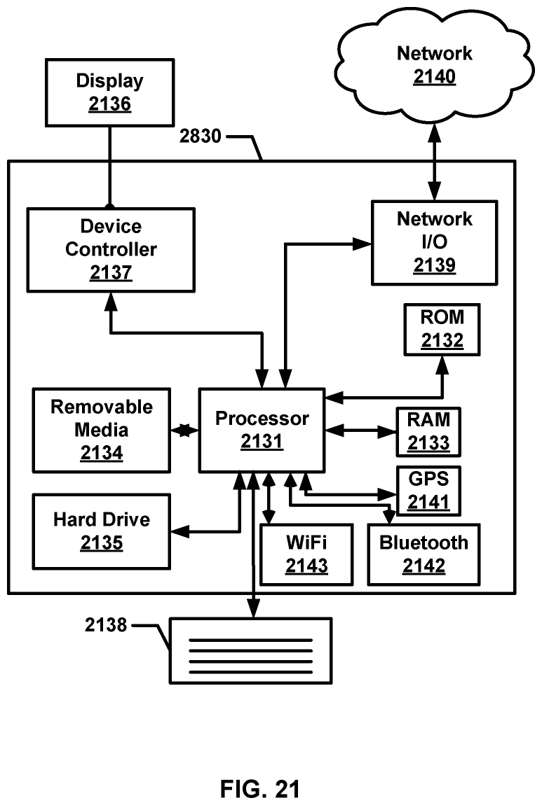

FIG. 21 shows example elements of a computing device that may be used to implement any of the various devices described herein, including, for example, a STA, an AP, communication devices, and/or any computing and/or communication device described herein. The computing device 2130 may comprise one or more processors 2131, which may execute instructions stored in the random-access memory (RAM) 2133, the removable media 2134 (such as a Universal Serial Bus (USB) drive, compact disk (CD) or digital versatile disk (DVD), or floppy disk drive), or any other desired storage medium. Instructions may also be stored in an attached (or internal) hard drive 2135. The computing device 2130 may also comprise a security processor (not shown), which may execute instructions of one or more computer programs to monitor the processes executing on the processor 2131 and any process that requests access to any hardware and/or software components of the computing device 2130 (e.g., ROM 2132, RAM 2133, the removable media 2134, the hard drive 2135, the device controller 2137, a network interface 2139, a GPS 2141, a Bluetooth interface 2142, a WiFi interface 2143, etc.). The computing device 2130 may comprise one or more output devices, such as the display 2136 (e.g., a screen, a display device, a monitor, a television, etc.), and may comprise one or more output device controllers 2137, such as a video processor. There may also be one or more user input devices 2138, such as a remote control, keyboard, mouse, touch screen, microphone, etc. The computing device 2130 may also comprise one or more network interfaces, such as a network interface 2139, which may be a wired interface, a wireless interface, or a combination of the two. The network interface 2139 may provide an interface for the computing device 2130 to communicate with a network 2140 (e.g., a RAN, or any other network). The network interface 2139 may comprise a modem (e.g., a cable modem), and the external network 2140 may comprise communication links, an external network, an in-home network, a provider's wireless, coaxial, fiber, or hybrid fiber/coaxial distribution system (e.g., a DOCSIS network), or any other desired network. Additionally, the computing device 2130 may comprise a location-detecting device, such as a global positioning system (GPS) microprocessor 2141, which may be configured to receive and process global positioning signals and determine, with possible assistance from an external server and antenna, a geographic position of the computing device 2130.

The example in FIG. 21 may be a hardware configuration, although the components shown may be implemented as software as well. Modifications may be made to add, remove, combine, divide, etc. components of the computing device 2130 as desired. Additionally, the components may be implemented using basic computing devices and components, and the same components (e.g., processor 2131, ROM storage 2132, display 2136, etc.) may be used to implement any of the other computing devices and components described herein. For example, the various components described herein may be implemented using computing devices having components such as a processor executing computer-executable instructions stored on a computer-readable medium, as shown in FIG. 21. Some or all of the entities described herein may be software based, and may co-exist in a common physical platform (e.g., a requesting entity may be a separate software process and program from a dependent entity, both of which may be executed as software on a common computing device).

A computing device may perform a method comprising multiple operations. A first WiFi access point may send, to a second WiFi access point, a Coordinated Beamforming (Co-BF) invite frame. The Co-BF invite frame comprises an invitation to the second WiFi access point for a multi-access point Co-BF transmission initiated by the first WiFi access point. The first WiFi access point may receive, from the second WiFi access point, a frame. The frame may indicate a reason for a rejection of the invitation. The frame may indicate a rejection of the invitation and a reason for the rejection. The frame further may indicate a time period. The first WiFi access point may send, to the second WiFi access point, a second Co-BF invite frame, for example, after a time period that may be based on the reason for the rejection of the invitation. The reason for the rejection indicates at least one of: unavailability of a first station associated with the second WiFi access point; unavailability of the second WiFi access point; an error in channel state information associated with a channel between a second station and the second WiFi access point; an absence of buffered units, at the second WiFi access point, for a third station associated with the second WiFi access point; or an unspecified reason. The first WiFi access point may send, to the second WiFi access point, a second Co-BF invite frame comprising a second invitation for a second multi-access point Co-BF transmission. The first WiFi access point may receive, from the second WiFi access point, a second frame indicating acceptance of the second invitation. The first WiFi access point may send, to the second WiFi access point, a third Co-BF invite frame, for example, based on the second frame. The Co-BF invite frame may further comprise an unavailability period feedback field comprising: a start time; and a duration. The Co-BF invite frame may comprise a coordinated beamforming response frame. The multi-access point Co-BF transmission comprises at least one of: coordinated beamforming; coordinated spatial reuse; or coordinated sounding. The computing device may comprise one or more processors; and memory storing instructions that, when executed by the one or more processors, cause the computing device to perform the described method, additional operations and/or include the additional elements. A system may comprise a first WiFi access point configured to perform the described method, additional operations and/or include the additional elements; and a second WiFi access point configured to send the frame. A computer-readable medium may store instructions that, when executed, cause performance of the described method, additional operations, and/or include the additional elements.

A computing device may perform a method comprising multiple operations. A first WiFi access point may send, to a second WiFi access point, a Coordinated Beamforming (Co-BF) invite frame. The Co-BF invite frame comprises an invitation to the second WiFi access point for a multi-access point Co-BF transmission initiated by the first WiFi access point. The first WiFi access point may receive, from the second WiFi access point, a frame indicating rejection of the invitation and a time period. The first WiFi access point may send, to the second WiFi access point and after the time period, a second Co-BF invite frame. The frame further indicates the time period associated with unavailability for the multi-access point Co-BF transmission. The second Co-BF invite frame comprises a second invitation for a second multi-access point Co-BF transmission. The time period may be based on a start time associated with a sounding procedure for the multi-access point Co-BF transmission. The first WiFi access point may send, to the second WiFi access point and after the time period, a second frame configured to indicate a sounding procedure for the multi-access point coordinated transmission. The multi-access point Co-BF transmission comprises coordinated beamforming, coordinated spatial reuse, or coordinated sounding. The computing device may comprise one or more processors; and memory storing instructions that, when executed by the one or more processors, cause the computing device to perform the described method, additional operations and/or include the additional elements. A system may comprise a first WiFi access point configured to perform the described method, additional operations and/or include the additional elements; and a second WiFi access point configured to send the frame. A computer-readable medium may store instructions that, when executed, cause performance of the described method, additional operations, and/or include the additional elements.

A computing device may perform a method comprising multiple operations. A second WiFi access point may receive, from a first access point, a Coordinated Beamforming (Co-BF) invite frame. The Co-BF invite frame. The Co-BF invite frame comprises an invitation to the second WiFi access point for a multi-access point CoBF transmission initiated by the first WiFi access point. The second WiFi access point may send, to the first WiFi access point, a frame. The frame may indicate a reason for a rejection of the invitation. The frame may indicate a rejection of the invitation and a reason for the rejection. The frame may further indicate a time period. The second WiFi access point may receive, from the first WiFi access point, a second Co-BF invite frame comprising a second invitation for a second multi-access point Co-BF transmission. The second WiFi access point may send, to the first WiFi access point, a second frame indicating acceptance of the second invitation. The second WiFi access point may receive, from the first WiFi access point, a third Co-BF invite frame, for example, based on the second frame. The reason for the rejection indicates at least one of: unavailability of a first station associated with the second WiFi access point; unavailability of the second WiFi access point; an error in channel state information associated with a channel between a second station and the second WiFi access point; an absence of buffered units, at the second WiFi access point, for a third station associated with the second WiFi access point; or an unspecified reason. The Co-BF invite frame further comprises an unavailability period feedback field comprising a start time and/or a duration. The Co-BF invite frame comprises a coordinated beamforming response frame. The computing device may comprise one or more processors; and memory storing instructions that, when executed by the one or more processors, cause the computing device to perform the described method, additional operations and/or include the additional elements. A system may comprise a second WiFi access point configured to perform the described method, additional operations and/or include the additional elements; and a first WiFi access point configured to send the Co-BF invite frame. A computer-readable medium may store instructions that, when executed, cause performance of the described method, additional operations, and/or include the additional elements.

A computing device may perform a method comprising multiple operations. A second WiFi access point may receive, from a first access point, a Coordinated Beamforming (Co-BF) invite frame. The Co-BF invite frame may comprise an invitation to the second WiFi access point for a multi-WiFi access point coordinated transmission initiated by the first access point. The second WiFi access point may send, to the first access point, a second frame. The second frame may indicate a reason for a rejection of the invitation. The second frame may indicate a rejection of the invitation and a reason for the rejection. The second WiFi access point may receive, from the first access point, a third frame of the first type, for example, based on the second frame. The second frame may further indicate a time period. The second WiFi access point may receive the third frame, for example, after a time period that may be based on the reason for the rejection of the invitation. The third frame comprises a second invitation to join a second multi-AP coordinated transmission. The second WiFi access point may receive, from the first access point, a fourth frame configured to initiate a sounding sequence for the multi-access point Co-BF transmission. The Co-BF invite frame may comprise a coordinated beamforming response frame. The computing device may comprise one or more processors; and memory storing instructions that, when executed by the one or more processors, cause the computing device to perform the described method, additional operations and/or include the additional elements. A system may comprise a second WiFi access point configured to perform the described method, additional operations and/or include the additional elements; and a first WiFi access point configured to send the Co-BF invite frame. A computer-readable medium may store instructions that, when executed, cause performance of the described method, additional operations, and/or include the additional elements.

A computing device may perform a method comprising multiple operations. A first access point (AP) may send (or transmit), for example, to a second AP, a first frame of a first type. The first frame may comprise an invitation to the second AP to join a multi-AP coordinated transmission initiated by the first AP. The first AP may receive, from the second AP, a second frame indicating rejection of the invitation and/or a reason for the rejection. The first AP may transmit, to the second AP, a third frame of the first type after a first time period. The first time period may be based on the reason. A first AP may receive, from a second AP, a first frame indicating rejection of a first invitation from the first AP to join a first multi-AP coordinated transmission and a reason for the rejection. The reason for the rejection may comprise unavailability of the first STA associated with the second AP. The unavailability of the first STA may be during the first multi-AP coordinated transmission. The unavailability of the first STA may relate to a power save mode or a coexistence event for the first STA. The reason for the rejection may comprise unavailability of the second AP. The first start time may indicate a time at which the second AP becomes unavailable for the first multi-AP coordinated transmission, and wherein the first duration indicates a duration after the first start time during which the second AP remains unavailable for the first multi-AP coordinated transmission. The first start time may indicate a time at which the first STA becomes unavailable for the first multi-AP coordinated transmission. The first duration may indicate a duration after the first start time during which the first STA remains unavailable for the first multi-AP coordinated transmission. The reason for the rejection comprises the error in CSI relating to the channel between the second STA and the second AP. The error in CSI relating to the second STA may comprise an error in receiving CSI feedback from the second STA. The error in CSI relating to the second STA may comprise a failure to update CSI feedback relating to the second STA within a time interval. The time interval may be greater than 10 ms and less than 100 ms. The second STA may be associated with the first AP. The second STA may be associated with the second AP. The reason for the rejection comprises the unspecified reason. The first frame indicates the unspecified reason using a pre-determined code value. The receiving of the first frame, from the second AP, may be based on (e.g., in response to) transmitting the second frame. The second frame comprises a coordinated beamforming (CoBF) request frame. The second invitation comprises a retransmission of the first invitation. The third frame comprises a coordinated beamforming (CoBF) request frame. The first time period is based on the reason. The first frame further comprises an unavailability period feedback field indicating a start time and/or a duration, and wherein the first time period is based on the start time and the duration. The first frame further indicates a second time period. The first time period is further based on the second time period. The second time period is equal to the first time period. The first frame further indicates that the first time period is based on a start of a sounding procedure for the first multi-AP coordinated transmission. The computing device may comprise one or more processors; and memory storing instructions that, when executed by the one or more processors, cause the computing device to perform the described method, additional operations and/or include the additional elements. A system may comprise a first access point configured to perform the described method, additional operations and/or include the additional elements; and a second access point configured to send the second frame. A computer-readable medium may store instructions that, when executed, cause performance of the described method, additional operations, and/or include the additional elements.

A computing device may perform a method comprising multiple operations. A first access point (AP) may receive, for example, from a second AP, a first frame of a first type. The first frame comprises an invitation to the second AP to join a multi-AP coordinated transmission initiated by the first AP. The first AP may receive, from the second AP, a second frame indicating rejection of the invitation and/or a first time period. The first AP may transmit, to the second AP, a second frame of the first type after the first time period. The first AP may receive, by the first AP from the second AP, a first frame indicating: rejection of a first invitation to join a first multi-AP coordinated transmission; and an indication of a first time period relating to unavailability for the first multi-AP coordinated transmission. The first AP may transmit, to the second AP, a second frame comprising the first invitation. The receiving of the first frame, from the second AP, may be based on (e.g., in response to) transmitting the second frame. The first AP may transmit, to the second AP, a third frame comprising a second invitation to join a second multi-AP coordination transmission, for example, after the first time period. The indication of the first time period comprises the first time period. The indication of the first time period comprises an indication that the first time period may be based on a start of a sounding procedure for the first multi-AP coordinated transmission. The first AP may transmit, to the second AP, a fourth frame initiating the sounding procedure for the first multi-AP coordinated transmission, for example, after the first time period. The first multi-AP coordinated transmission comprises a coordinated beamforming (CoBF), a coordinated spatial reuse (CoSR), or a coordinated sounding operation. The computing device may comprise one or more processors; and memory storing instructions that, when executed by the one or more processors, cause the computing device to perform the described method, additional operations and/or include the additional elements. A system may comprise a first access point configured to perform the described method, additional operations and/or include the additional elements; and a second access point configured to send the second frame. A computer-readable medium may store instructions that, when executed, cause performance of the described method, additional operations, and/or include the additional elements.

A computing device may perform a method comprising multiple operations. A first access point (AP) may send (or transmit), for example, to a second AP, a first frame of a first type. The first frame comprises an invitation to the second AP to join a multi-AP coordinated transmission initiated by the first AP. The first AP may receive, from the second AP, a second frame indicating rejection of the invitation and/or a first time period. The first AP may transmit, to the second AP, a second frame of the first type after the first time period. The first AP may receive, from the second AP, a first frame indicating rejection of a first invitation to join a first multi-AP coordinated transmission and/or an indication of a first time period relating to unavailability for the first multi-AP coordinated transmission. The first AP may transmit, to the second AP, a second frame comprising the first invitation. The receiving of the first frame, from the second AP, may be based on (e.g., in response to) transmitting the second frame. The first AP may transmit, to the second AP, a third frame comprising a second invitation to join a second multi-AP coordination transmission, for example, after the first time period. The indication of the first time period comprises the first time period. The indication of the first time period comprises an indication that the first time period may be based on a start of a sounding procedure for the first multi-AP coordinated transmission. The first AP may transmit, to the second AP, a fourth frame initiating the sounding procedure for the first multi-AP coordinated transmission, for example, after the first time period. The first multi-AP coordinated transmission comprises a coordinated beamforming (CoBF), a coordinated spatial reuse (CoSR), or a coordinated sounding operation. The computing device may comprise one or more processors; and memory storing instructions that, when executed by the one or more processors, cause the computing device to perform the described method, additional operations and/or include the additional elements. A system may comprise a first access point configured to perform the described method, additional operations and/or include the additional elements; and a second access point configured to send the second frame. A computer-readable medium may store instructions that, when executed, cause performance of the described method, additional operations, and/or include the additional elements.

A computing device may perform a method comprising multiple operations. A first access point (AP) may receive, for example, to a second AP, a first frame of a first type. The first frame comprises an invitation to the first AP to join a multi-AP coordinated transmission initiated by the second AP. The first AP may transmit, to the second AP, a second frame indicating: rejection of the invitation; and a first time period. The first AP may receive, AP from the second AP, a second frame of the first type after the first time period. The first AP may transmit, to the second AP, a first frame indicating rejection of a first invitation to join a first multi-AP coordinated transmission and/or an indication of a first time period relating to unavailability for the first multi-AP coordinated transmission. The first AP may receive, the second AP, a second frame comprising the first invitation. The transmitting of the first frame, to the second AP, may be based on (e.g., in response to) receiving the second frame. The first AP may receive, from the second AP and after the first time period, a third frame comprising a second invitation to join a second multi-AP coordination transmission. The indication of the first time period comprises the first time period. The indication of the first time period comprises an indication that the first time period is based on a start of a sounding procedure for the first multi-AP coordinated transmission. The first AP may receive, from the second AP and after the first time period, a fourth frame initiating the sounding procedure for the first multi-AP coordinated transmission. The first multi-AP coordinated transmission comprises a coordinated beamforming (CoBF), a coordinated spatial reuse (CoSR), or a coordinated sounding operation. The computing device may comprise one or more processors; and memory storing instructions that, when executed by the one or more processors, cause the computing device to perform the described method, additional operations and/or include the additional elements. A system may comprise a first access point configured to perform the described method, additional operations and/or include the additional elements; and a second access point configured to send the first frame. A computer-readable medium may store instructions that, when executed, cause performance of the described method, additional operations, and/or include the additional elements.

One or more of the operations described herein may be conditional. For example, one or more operations may be performed if certain criteria are met, such as in a wireless device, a base station, a radio environment, a network, a combination of the above, and/or the like. Example criteria may be based on one or more conditions such as wireless device and/or network node configurations, traffic load, initial system set up, packet sizes, traffic characteristics, a combination of the above, and/or the like. If the one or more criteria are met, various examples may be used. It may be possible to implement any portion of the examples described herein in any order and based on any condition.

An access point (and an AP MLD) may communicate with one or more wireless devices (e.g., computing device(s), non-AP MLD(s), station(s), etc.). Computing devices described herein may support multiple technologies, and/or multiple releases of the same technology. Computing devices may have some specific capability(ies) depending on wireless device category and/or capability(ies). Computing devices referred to herein may correspond to a plurality of computing devices compatible with a given LTE, 5G, 3GPP or non-3GPP release, IEEE 802.11 Standard(s) (e.g., IEEE 802.11be, beyond IEEE 802.11be), or Wi-Fi Alliance (WFA) Standard(s) (e.g., Wi-Fi 7, Wi-Fi 8) technology. A plurality of computing devices may refer to a selected plurality of wireless devices, a subset of total wireless devices in a coverage area, and/or any group of wireless devices. Such devices may operate, function, and/or perform based on or according to drawings and/or descriptions herein, and/or the like. There may be a plurality of access points and/or a plurality of wireless devices in a coverage area that may not comply with the disclosed methods, for example, because those wireless devices and/or access points may perform based on other (e.g., older or newer) releases of LTE, 5G, 6G, 3GPP or non-3GPP, IEEE 802.11 Standards (e.g., IEEE 802.11be, beyond IEEE 802.11be), or Wi-Fi Alliance (WFA) Standards (e.g., Wi-Fi 7, Wi-Fi 8) technology.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or Lab VIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as access points (APs), AP multi-link devices (MLDs), stations (STAs), non-AP STAs, non-AP MLDs, base stations, wireless devices or user equipment (wireless device), servers, switches, antennas, and/or the like. A network may comprise any wireless technology, including but not limited to, cellular, wireless, Wi-Fi, 4G, 5G, 6G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
sending, by a first WiFi access point to a second WiFi access point, a Coordinated Beamforming (Co-BF) invite frame, wherein the Co-BF invite frame comprises an invitation to the second WiFi access point for a multi-access point Co-BF transmission initiated by the first WiFi access point; and
receiving, from the second WiFi access point, a response frame indicating reason for a rejection of the invitation.

2. The method of claim 1, wherein the response frame further indicates a time period.

3. The method of claim 1, further comprising sending, to the second WiFi access point, a second Co-BF invite frame after a time period that is based on the reason for the rejection of the invitation.

4. The method of claim 1, wherein the reason for the rejection indicates at least one of:
unavailability of a first station associated with the second WiFi access point;
unavailability of the second WiFi access point;
an error in channel state information associated with a channel between a second station and the second WiFi access point;
an absence of buffered units, at the second WiFi access point, for a third station associated with the second WiFi access point; or
an unspecified reason.

5. The method of claim 1, further comprising:
sending, to the second WiFi access point, a second Co-BF invite frame comprising a second invitation for a second multi-access point Co-BF transmission;
receiving, from the second WiFi access point, a second response frame indicating acceptance of the second invitation; and
sending, to the second WiFi access point and based on the second response frame, a third Co-BF invite frame.

6. The method of claim 1, wherein the Co-BF invite frame further comprises an unavailability period feedback field comprising:
a start time; and
a duration.

7. The method of claim 1, wherein the Co-BF invite frame comprises a coordinated beamforming response frame.

8. The method of claim 1, wherein the multi-access point Co-BF transmission comprises at least one of:
coordinated beamforming;
coordinated spatial reuse; or
coordinated sounding.

9. A method comprising:
sending, by a first WiFi access point to a second WiFi access point, a Coordinated Beamforming (Co-BF) invite frame, wherein the Co-BF invite frame comprises an invitation to the second WiFi access point for a multi-access point Co-BF transmission initiated by the first WiFi access point;
receiving, from the second WiFi access point, a response frame indicating:
rejection of the invitation; and
a time period; and
sending, to the second WiFi access point and after the time period, a second Co-BF invite frame.

10. The method of claim 9, wherein the response frame further indicates the time period associated with unavailability for the multi-access point Co-BF transmission.

11. The method of claim 9, wherein the second Co-BF invite frame comprises a second invitation for a second multi-access point Co-BF transmission.

12. The method of claim 9, wherein the time period is based on a start time associated with a sounding procedure for the multi-access point Co-BF transmission.

13. The method of claim 9, further comprising:
sending, to the second WiFi access point and after the time period, a second response frame configured to indicate a sounding procedure for the multi-access point coordinated transmission.

14. The method of claim 9, wherein the multi-access point Co-BF transmission comprises at least one of: coordinated beamforming, coordinated spatial reuse, or coordinated sounding.

15. A method comprising:
receiving, by a second WiFi access point from a first WiFi access point, a Coordinated Beamforming (Co-BF) invite frame, wherein the Co-BF invite frame comprises an invitation to the second WiFi access point for a multi-access point CoBF transmission initiated by the first WiFi access point; and
sending, to the first WiFi access point, a response frame indicating reason for a rejection of the invitation.

16. The method of claim 15, wherein the response frame further indicates a time period.

17. The method of claim 15, further comprising:
receiving, from the first WiFi access point, a second Co-BF invite frame comprising a second invitation for a second multi-access point Co-BF transmission;
sending, to the first WiFi access point, a second response frame indicating acceptance of the second invitation; and
receiving, from the first WiFi access point and based on the second response frame, a third Co-BF invite frame.

18. The method of claim 15, wherein the reason for the rejection indicates at least one of:
unavailability of a first station associated with the second WiFi access point;
unavailability of the second WiFi access point;
an error in channel state information associated with a channel between a second station and the second WiFi access point;
an absence of buffered units, at the second WiFi access point, for a third station associated with the second WiFi access point; or
an unspecified reason.

19. The method of claim 15, wherein the Co-BF invite frame further comprises an unavailability period feedback field comprising:
a start time; and
a duration.

20. The method of claim 15, wherein the Co-BF invite frame comprises a coordinated beamforming response frame.
